(19) United States
(12) Patent Application Publication
(10) Pub. No.: US 2026/0156277 A1
(43) Pub. Date: Jun. 4, 2026

(54) OPERATION METHOD OF MULTI-CODEC CIRCUIT

(71) Applicant: SAMSUNG ELECTRONICS CO., LTD., Suwon-si (KR)

(72) Inventor: In-Hwan Kim, Suwon-si (KR)

(73) Assignee: SAMSUNG ELECTRONICS CO., LTD., Suwon-si (KR)

(21) Appl. No.: 19/346,980

(22) Filed: Oct. 1, 2025

(30) Foreign Application Priority Data
Nov. 29, 2024 (KR) 10-2024-0174780

(51) Int. Cl. H04N 19/196; H04N 19/167; H04N 19/184

(52) U.S. Cl. CPC H04N 19/196; H04N 19/167; H04N 19/184

(57) ABSTRACT

A method of operating a multi-codec circuit configured to support a plurality of codecs, may include selecting a current coding tree unit (CTU) from a plurality of CTUs partitioned from an input image, selecting a current coding unit (CU) from a plurality of CUs partitioned from the current CTU, determining availability of neighbor CUs of the current coding unit based on a coding unit bitmap, and performing signal processing on the current CU using at least one of the neighbor CUs that is determined to be available. The coding unit bitmap may include a plurality of bits, each indicating whether signal processing has been performed for a corresponding coding unit, among the plurality of CUs. Each of the plurality of bits may correspond to a minimum CU supported by each of the plurality of codecs.

### CROSS-REFERENCE TO RELATED APPLICATIONS

This application claims priority under 35 U.S.C. § 119 to Korean Patent Application No. 10-2024-0174780 filed on Nov. 29, 2024, in the Korean Intellectual Property Office, the disclosures of which are incorporated by reference herein in their entireties.

### BACKGROUND

Embodiments of the present disclosure described herein relate to image processing, and more particularly, relate to an operation method of a multi-codec circuit for processing image data.

As the resolution of display devices increases recently, a size of image data displayed through the display devices also increases. To efficiently manage the large volume of image data, various video codecs have been developed and are actively being used.

Each of the various video codecs is standardized in various forms. To support various video codecs, it may be necessary to individually develop video codec encoders and video codec decoders that comply with the respective standards.

### SUMMARY

Embodiments of the present disclosure provide a method of operating a multi-codec circuit that achieves reduced cost and improved performance.

According to an embodiment of the present disclosure, a method of operating a multi-codec circuit configured to support a plurality of codecs includes selecting a current coding tree unit (CTU) from a plurality of CTUs partitioned from an input image, selecting a current coding unit (CU) from a plurality of CUs partitioned from the current CTU, determining availability of neighbor CUs of the current coding unit based on a coding unit bitmap, performing signal processing on the current CU using at least one available neighbor CU based on a result of determining the availability of the neighbor CUs. The coding unit bitmap may include a plurality of bits, each of the plurality of bits indicating whether signal processing has been performed for a corresponding coding unit, among the plurality of CUs. Each of the plurality of bits corresponds to a minimum CU supported by each of the plurality of codecs.

According to an embodiment of the present disclosure, a method of operating a multi-codec circuit configured to support a plurality of codecs includes determining availability of first neighbor coding units (CUs) of a first CU, among a plurality of CUs partitioned from a first coding tree unit (CTU), based on a coding unit bitmap, performing first signal processing on the first CU using the first neighbor CUs based on the first neighbor CUs being determined as available for the first signal processing, based on the first signal processing being completed, setting first current coding bits corresponding to the first CU to a first value in the coding unit bitmap, determining availability of second neighbor CUs of a second CU among the plurality of CUs, based on the coding unit bitmap, performing a second signal processing on the second CU using the second neighbor CUs based on the second neighbor CUs being determined as available for the second signal processing, and based on the second signal processing being completed, setting second current coding bits corresponding to the second CU to the first value, in the coding unit bitmap. The coding unit bitmap may include a plurality of bits indicating whether signal processing has been performed for the plurality of CUs. Each of the plurality of bits may correspond to a minimum CU supported by each of the plurality of codecs.

According to an embodiment of the present disclosure, a method of operating a multi-codec circuit configured to support a plurality of codecs includes clearing a coding unit bitmap to a reset value, determining availability of first neighbor coding units (CUs) of a first CU in a first coding tree unit (CTU), based on the coding unit bitmap, performing first signal processing on the first CU using the first neighbor CUs based on the first neighbor CUs being determined as available for the first signal processing, setting first current coding bits corresponding to the first CU to a first value, in the coding unit bitmap, clearing the coding unit bitmap to the reset value, determining availability of second neighbor CUs of a second CU in a second CTU, based on the coding unit bitmap, performing a second signal processing on the second CU using the second neighbor CUs based on the second neighbor CUs being determined as available for the second signal processing, and setting second current coding bits corresponding to the second CU to the first value, in the coding unit bitmap. A size of the first CTU is different from a size of the second CTU. The coding unit bitmap may include a plurality of bits indicating whether signal processing has been performed for a plurality of CUs including the first CU, the second CU, the first neighbor CUs, and the second neighbor CUs. Each of the plurality of bits corresponds to a minimum CU supported by each of the plurality of codecs.

According to an embodiment of the present disclosure, an electronic device may include: memory storing instructions and a coding unit bitmap; and at least one processor configured to execute the instructions to: select a current coding tree unit (CTU) from a plurality of CTUs partitioned from an input image, select a current coding unit (CU) from a plurality of CUs partitioned from the current CTU, determine availability of neighbor CUs of the current coding unit based on the coding unit bitmap that includes a plurality of bits, each of the plurality of bits indicating whether signal processing has been performed for a corresponding coding unit, among the plurality of CUs, perform signal processing on the current CU using at least one of the neighbor CUs being determined to be available, and update coding bits corresponding to the current coding unit in the coding unit bitmap, based on a completion of the signal processing for the current CU.

### BRIEF DESCRIPTION OF DRAWINGS

The above and other objects and features of the present disclosure will become apparent by describing in detail embodiments thereof with reference to the accompanying drawings.

FIG. 1 is a diagram illustrating a system 1000 according to one or more embodiments of the present disclosure.

FIG. 2 is a block diagram illustrating a multi-codec circuit of FIG. 1 according to one or more embodiments.

FIGS. 3, 4A, and 4B are diagrams for describing a coding tree unit and a coding unit for an input image according to one or more embodiments.

FIG. 5 is a diagram for describing a coding unit partitioning method used in various codecs according to one or more embodiments.

FIGS. 6A and 6B are diagrams for describing an operation for determining availability of neighbor coding units according to one or more embodiments.

FIG. 7 is a block diagram illustrating a multi-codec circuit of FIG. 1 according to one or more embodiments.

FIG. 8 is a block diagram illustrating a coding unit availability check block of FIG. 7 according to one or more embodiments.

FIG. 9 is a flowchart illustrating an operation of a multi-codec circuit of FIG. 7 according to one or more embodiments.

FIGS. 10A, 10B, 11A, and 11B illustrate an operation of a coding unit availability check block of FIG. 8 according to one or more embodiments.

FIGS. 12A and 12B illustrate an operation of a coding unit availability check block of FIG. 8 according to one or more embodiments.

FIGS. 13A, 13B, 14A, and 14B illustrate an operation of a coding unit availability check block of FIG. 8 according to one or more embodiments.

FIGS. 15A and 15B illustrate an operation of a coding unit availability check block of FIG. 8 according to one or more embodiments.

FIGS. 16A and 16B illustrate an operation of a coding unit availability check block of FIG. 8 according to one or more embodiments.

FIG. 17 illustrates a coding tree unit and a coding unit for an input image processed by a multi-codec circuit of FIG. 1 according to one or more embodiments.

FIG. 18 is a block diagram schematically illustrating a multi-codec circuit, according to one or more embodiments of the present disclosure.

### DETAILED DESCRIPTION

Hereinafter, embodiments of the present disclosure may be described in detail and clearly to such an extent that an ordinary one in the art easily implements the present disclosure.

Hereinafter, components described with reference to terms such as “part” (or “unit”), “block”, “module” etc. used in the detailed description and function blocks illustrated in drawings may be implemented in the form of software, hardware, or a combination thereof. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

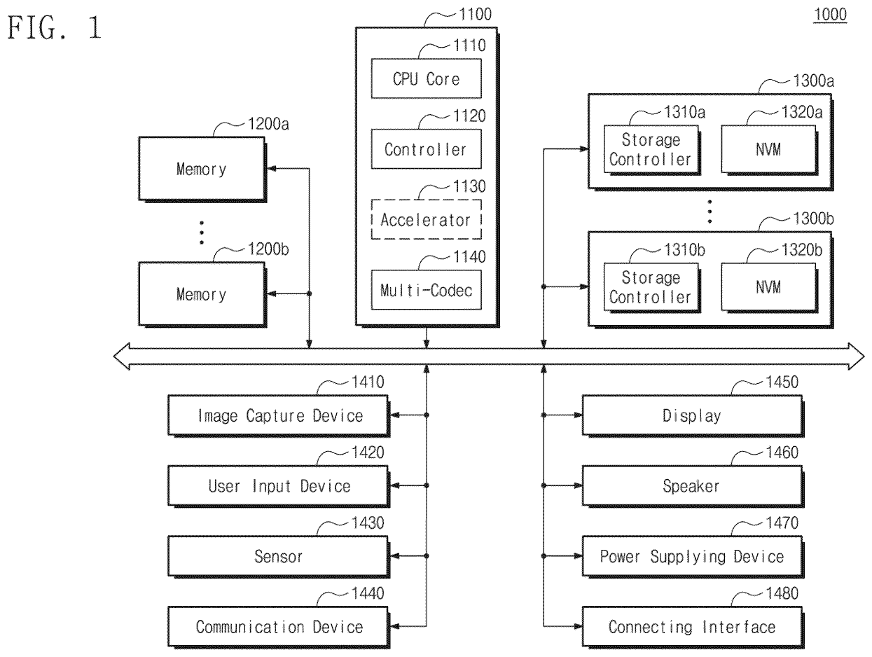

FIG. 1 is a diagram of a system 1000 including a storage device according to one or more embodiments. The system 1000 of FIG. 1 may be a mobile system, such as a portable communication terminal (e.g., a mobile phone), a smartphone, a tablet personal computer (PC), a wearable device, a healthcare device, or an Internet of things (IOT) device. However, the system 1000 of FIG. 1 is not necessarily limited to the mobile system and may be a PC, a laptop computer, a server, a media player, or an automotive device (e.g., a navigation device).

Referring to FIG. 1, the system 1000 may include a main processor 1100, memories 1200a and 1200b, and storage devices 1300a and 1300b. In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one central processing unit (CPU) core 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and non-volatile memories (NVMs) 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 in the system 1000 or implemented in the same package as the main processor 1100. In addition, the storage devices 1300a and 1300b may have types of solid-state devices (SSDs) or memory cards and be removably combined with other components of the system 1000 through an interface, such as the connecting interface 1480 that will be described below. The storage devices 1300a and 1300b may operate according to a standard protocol, such as a universal flash storage (UFS), an embedded multi-media card (eMMC), or a non-volatile memory express (NVMe), without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

In one or more embodiments, the main processor 1100 may be a system on chip (SoC) that includes functional blocks or intellectual property (IP) blocks configured to implement various functions. As an example, the main processor 1100 may further include a multi-codec circuit 1140. The multi-codec circuit 1140 may be a logic circuit or a hardware circuit configured to support various video/image codecs.

As an example, the multi-codec circuit 1140 may be configured to support various video/image codecs such as H.264, High Efficiency Video Codec (HEVC), High Efficiency Image Codec (HEIC), AOMedia Video 1 (AV1), Versatile Video Coding (VVC), Audio Video Coding Standard 3 (AVS3), etc. The multi-codec circuit 1140 may perform encoding and decoding operations corresponding to each of the plurality of codecs. In one or more embodiments, the various video/image codecs described above may have their own appropriate standards, and the multi-codec circuit 1140 may perform encoding and decoding operations as defined in the corresponding codec standards.

For example, to satisfy the standards defined by various codecs, individual components may be required for each of the various codecs, and in this case, it may be burdensome to implement the multi-codec circuit 1140. In addition, when an additional codec is developed in addition to the existing codecs, a separate means for applying the additional codec may be required.

According to one or more embodiments of the present disclosure, the multi-codec circuit 1140 may include a logic circuit configured to check the availability of neighbor coding units for each of the various codecs (e.g., whether signal processing for a neighbor coding unit is completed). In this case, even if the size, shape, processing order, or partitioning method of coding units varies across different codecs, the availability of neighbor coding units may be easily determined. The configuration of the multi-codec circuit 1140 according to one or more embodiments of the present disclosure will be described in more detail with reference to the drawings below.

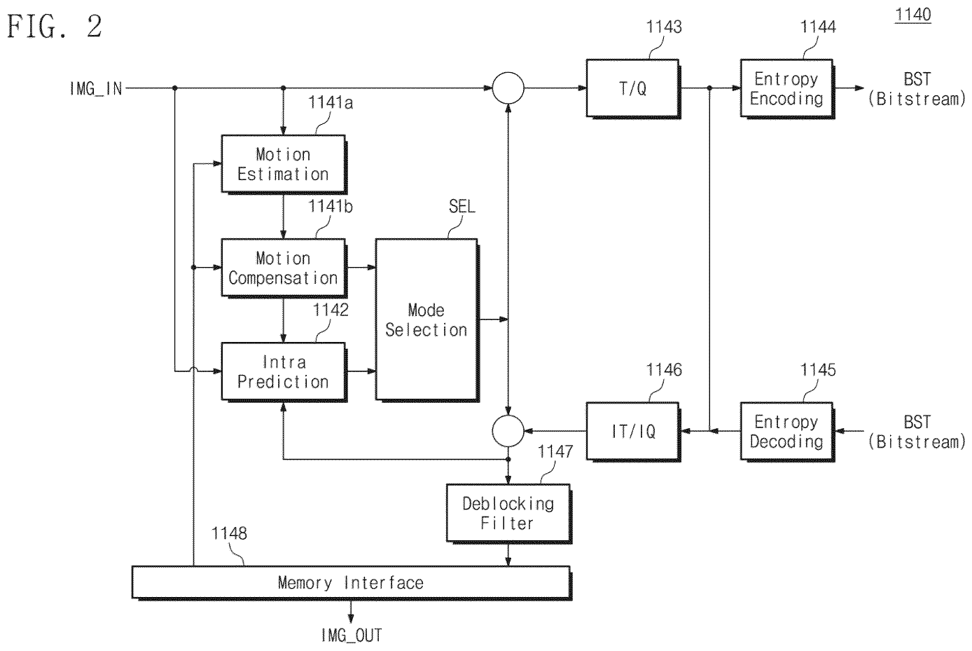

FIG. 2 is a block diagram illustrating a multi-codec circuit of FIG. 1 according to one or more embodiments. For convenience of description, some configurations of the multi-codec circuit 1140 are illustrated in FIG. 2, but the scope of the present disclosure is not limited thereto. The multi-codec circuit 1140 of FIG. 2 is described as performing encoding and decoding based on High Efficiency Video Codec (HEVC, also known as H.265), but the scope of the present disclosure is not limited thereto, and the multi-codec circuit 1140 may perform or support encoding and decoding corresponding to various video/image codecs.

Hereinafter, the terms “signal processing for an input image,” “coding tree unit,” or “coding unit” are used. In this case, signal processing may refer to performing encoding or decoding based on a corresponding codec with respect to target information (e.g., the input image, the coding tree unit, or the coding unit). For example, signal processing for the coding unit may refer to performing operations such as intra prediction, motion prediction, and motion compensation corresponding to the coding unit. However, the scope of the present disclosure is not limited thereto.

In one or more embodiments, the multi-codec circuit 1140 may perform signal processing on an input image IMG_IN based on a coding tree unit CTU. For example, the multi-codec circuit 1140 may partition the input image IMG_IN into a plurality of coding tree units. The coding tree unit CTU may be a basic processing unit for inter prediction or other signal processing. The multi-codec circuit 1140 may partition each of the plurality of coding tree units into smaller coding units CU. The multi-codec circuit 1140 may perform inter prediction or signal processing in units of coding units.

Hereinafter, for convenience of description, the multi-codec circuit 1140 is described as performing signal processing in units of coding units CU. However, the scope of the present disclosure is not limited thereto. For example, depending on the type or kind of the supported codec, the coding tree unit CTU may be partitioned into the coding unit CU or a prediction unit PU. Alternatively, the coding unit CU may be further partitioned into coding blocks or prediction blocks. In this case, the multi-codec circuit 1140 may perform signal processing on the coding unit CU or the prediction unit PU. As an example, when the multi-codec circuit 1140 performs signal processing on the prediction unit PU, the embodiments described below may be applied to determine the availability of neighbor prediction units PU. As described above, in the signal processing process for the input image IMG_IN, terms such as the coding tree unit CTU, the coding unit CU, a coding block CB, the prediction unit PU, a prediction block PB, and a super block may be used interchangeably depending on the type or kind of the codec. In this case, it will be understood that the embodiments of the present disclosure are not limited to the terms described above, and the embodiments of the present disclosure may be applied to checking the availability of neighbor coding units, neighbor prediction units, or neighbor blocks, etc.

Referring to FIGS. 1 and 2, the multi-codec circuit 1140 may perform encoding on an input image IMG_IN to generate a bit stream BST in which the input image IMG_IN is compressed. Alternatively, the multi-codec circuit 1140 may perform decoding on the bit stream BST to generate an output image IMG_OUT. The output image IMG_OUT may be displayed through an external display device (e.g., the display 1450 of FIG. 1) or may be stored in a separate memory.

The multi-codec circuit 1140 may include a motion estimation block 1141a, a motion compensation block 1141b, an intra prediction block 1142, a mode selection block SEL, a transform and quantization block 1143, an entropy coding block 1144, an entropy decoding block 1145, an inverse quantization and inverse transform block 1146, a deblocking filter 1147, and a memory interface block 1148.

The motion estimation block 1141a may estimate a motion between the input image IMG_IN and reference images. The motion estimation block 1141a may output motion information corresponding to the estimated motion. In one or more embodiments, the reference images may be images of previous frames of the input image IMG_IN and may be stored in a separate buffer memory (e.g., a memory connected to the memory interface block 1148). The motion compensation block 1141b may receive the motion information from the motion estimation block 1141a and may perform a motion compensation based on the motion information. In one or more embodiments, inter prediction for the input image IMG_IN may be performed by the motion estimation block 1141a and the motion compensation block 1141b.

The intra prediction block 1142 may be configured to perform intra prediction on the input image IMG_IN. For example, the intra prediction block 1142 may perform spatial prediction using information of signal-processed coding units among coding units adjacent to the coding unit currently being signal-processed.

The mode selection block SEL may be configured to select whether the current input image IMG_IN, the current coding tree unit CTU, or the current coding unit CU is in inter prediction mode or intra prediction mode. The result selected by the mode selection block SEL may be combined with the input image IMG_IN and may be provided to the transformation and quantization block 1143.

The transformation and quantization block 1143 may transform video information into frequency domain data. In one or more embodiments, the transform and quantization block 1143 may transform the received data into frequency domain data based on a discrete cosine transform (DCT) or other various transform examples. The transform and quantization block 1143 may quantize the frequency domain data.

The entropy coding block 1144 may perform entropy coding on the output of the transform and quantization block 1143 to generate the bit stream BST. The entropy coding block 1144 may be configured to perform various coding methods such as Huffman coding, run-length coding, differential coding, and similar coding thereto, but the scope of the present disclosure is not limited thereto. In one or more embodiments, the bit stream BST may be stored in a separate external memory.

The entropy decoding block 1145 may perform entropy decoding on the bit stream BST. In this case, the bit stream BST may be an entropy-encoded bit stream. In one or more embodiments, the entropy decoding block 1145 may perform the inverse transformation of the entropy encoding block 1144.

The inverse quantization and inverse transformation block 1146 may inverse quantize the quantized data and may transform the domain of the inverse quantized data.

The deblocking filter block 1147 may perform a filtering operation to reduce discontinuities at the boundaries of images or coding units and to attenuate ringing artifacts and sample distortions. In one or more embodiments, the deblocking filter block 1147 may further include a Sample Adaptive Offset (SAO).

The memory interface block 1148 may be configured to store the result of signal processing by the multi-codec circuit 1140 in an external memory or to transmit and receive the result of signal processing or frame image stored in the external memory. In one or more embodiments, the encoded bit stream BST may be stored in an external memory through the memory interface block 1148. Alternatively, the decoded output image IMG_OUT may be stored in an external memory through the memory interface block 1148. The output image IMG_OUT stored in the external memory may be displayed by a separate display device.

As described above, the multi-codec circuit 1140 may perform encoding on the input image IMG_IN to generate the bit stream BST in a compressed form of the input image IMG_IN or may perform decoding on the bit stream BST to generate the output image IMG_OUT.

The configuration of the multi-codec circuit 1140 of FIG. 2 is only an example, and the scope of the present disclosure is not limited thereto. For example, the multi-codec circuit 1140 may include hardware configurations configured to support various video/image codecs such as H.264, HEVC, HEIC, AV1, VVC, AVS3, etc.

In one or more embodiments, the intra prediction block 1142 of the multi-codec circuit 1140 may perform spatial prediction using the signal processing results of the current coding unit and the neighbor coding units. In this case, to use the signal processing results of the neighbor coding units, it should be determined whether signal processing for the neighbor coding units is completed. In the present disclosure, whether signal processing for the neighbor coding units is completed is referred to as “availability of the neighbor coding unit CU”. That is, a neighbor coding unit that is considered “available” indicates that the signal processing for the neighbor coding unit has been completed and that it may be used for signal processing operations (e.g., intra prediction) of the current coding unit.

In one or more embodiments, the coding tree unit may be defined in different sizes for the plurality of codecs. For example, in the H.264 codec, the CTU may have a size of 16×16, in the HEVC codec, the CTU may have a size of 16×16, 32×32, or 64×64, and in the VVC, AV1, or AVS3 codecs, the CTU may have a size of 32×32, 64×64, or 128×128. Alternatively, in each of the various existing codecs or codecs to be developed in the future, the size of the CTU may vary. In addition, the size or shape of the CU may vary depending on each codec. In addition, each of the plurality of codecs performs coding unit partition in a different manner. In this case, the size or shape of the coding unit may be different in each of the plurality of codecs.

As described above, depending on the type of codec, the size or shape of the coding tree unit and the coding unit may vary, and in this case, it may be difficult to determine the availability of the neighbor coding unit corresponding to the current coding unit. In addition, to determine the availability of the neighbor coding unit, individually defined information or individual hardware means may be required for each of the plurality of codecs.

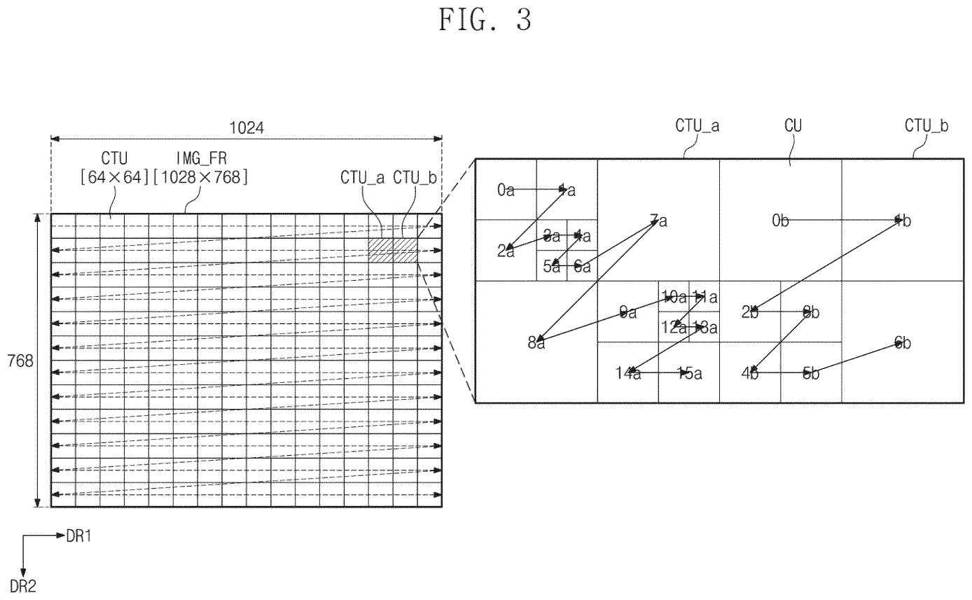

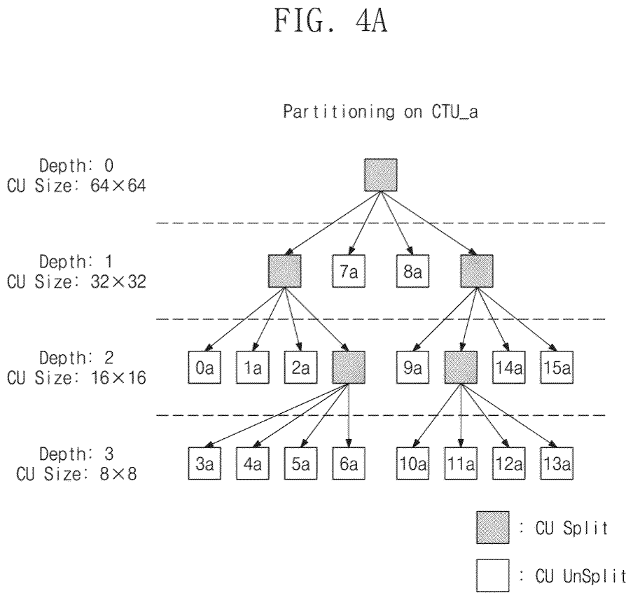

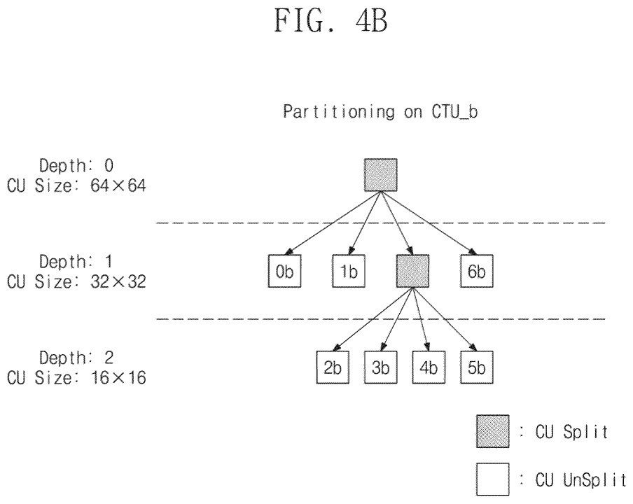

FIGS. 3, 4A, and 4B are diagrams for describing a coding tree unit and a coding unit for an input image according to one or more embodiments. For convenience of description, coding tree units and coding units based on the HEVC codec are described.

Referring to FIGS. 2 to 4B, the multi-codec circuit 1140 may perform encoding or decoding on the input image IMG_IN. In this case, it is assumed that the multi-codec circuit 1140 performs encoding or decoding based on the HEVC.

The input image IMG_IN may include 1024 pieces of pixel information in a first direction DR1 and 768 pieces of pixel information in a second direction DR2. That is, the input image IMG_IN may have a size of 1024×768.

The multi-codec circuit 1140 may partition the input image IMG_IN into coding tree units CTU of a size of 64×64. In detail, for the input image IMG_IN of the size of 1024×768, the coding tree units CTU of the size of 64×64 may be arranged in a form of 16×12 in the first and second directions DR1 and DR2.

The multi-codec circuit 1140 may perform signal processing on the coding tree units CTU in units of rows. For example, the multi-codec circuit 1140 may sequentially perform signal processing on the coding tree units CTU located in a first row in the first direction DR1, and then sequentially perform signal processing on the coding tree units CTU located in a second row adjacent to the first row in the second direction DR2, in the first direction DR1.

Each of the coding tree units CTU may be partitioned into the plurality of coding units CU. For example, an a-th coding tree unit CTU_a may be partitioned into 0a-th to 15a-th coding units Cu0a to CU15a (for the sake of brevity of the drawings, the “CU” among the reference numbers for the coding units is omitted in each drawing.) A b-th coding tree unit CTU_b may be partitioned into 0b-th to 6b-th coding units Cu0b to CU6b. The partitioning of the coding unit may be determined based on the pixel information included in the coding tree unit.

As an example, as illustrated in FIG. 4A, the a-th coding tree unit CTU_a may be partitioned into a depth of “3”. For example, the a-th coding tree unit CTU_a may be partitioned into four (4) coding units CUs with a depth of “1” (i.e., partitioned into 4 32×32 regions). Based on the pixel information, some of the regions of depth “1” are partitioned into four regions of a depth of “2” (i.e., each region is partitioned into four 16×16 regions). Based on the pixel information, some of the regions of depth “2” are partitioned into four regions of a depth of “3” (i.e., each region is partitioned into four 8×8 regions). In this case, the 7a-th and 8a-th coding units CU7a and CU8a of the a-th coding tree unit CTU_a have a depth of “1” and a size of 32×32, the 0a-th, 1a-th, 2a-th, 9a-th, 14a-th, and 15a-th coding units CU0a, CU1a, CU2a, CU9a, CU14a, and CU15a have a depth of “2” and a size of 16×16, and the 3a-th, 4a-th, 5a-th, 6a-th, 10a-th, 11a-th, 12a-th, and 13a-th coding units CU3a, CU4a, CU5a, CU6a, CU10a, CU11a, CU12a, and CU13a have a depth of “3” and a size of 8×8.

As in the above description, as illustrated in FIG. 4B, the b-th coding tree unit CTU_b may be partitioned into a depth of “2”. For example, the b-th coding tree unit CTU_b is partitioned into four (4) coding units CUs with a depth of “1” (i.e., partitioned into four 32×32 regions). Based on the pixel information, some of the regions of depth “1” are partitioned into four regions of a depth of “2” (i.e., each region is partitioned into four 16×16 regions). In this case, the 0b-th, 1b-th, and 6b-th coding units CU0b, CU1b, and CU6b of the b-th coding tree unit CTU_b may have a depth of “1” and a size of 32×32, and the 2b-th, 3b-th, 4b-th, and 5b-th coding units CU2b, CU3b, CU4b, and CU5b may have a depth of “2” and a size of 16×16.

As described above, in the input image IMG_IN, the coding tree unit CTU is partitioned into the same size, but the coding units may be partitioned into various sizes depending on the pixel information or channel characteristics of each region of the input image IMG_IN.

The multi-codec circuit 1140 may perform signal processing on the plurality of coding units CU in the order of a Z-scan order in each of the coding tree units CTU. For example, as illustrated in FIG. 3, the multi-codec circuit 1140 may sequentially perform signal processing on the 0a-th to 15a-th coding units CU0a to CU15a depending on the z-scan order when signal processing for the a-th coding tree unit CTU_a is performed. After signal processing for the a-th coding tree unit CTU_a is completed, the multi-codec circuit 1140 may perform signal processing on the b-th coding tree unit CTU_b. The multi-codec circuit 1140 may sequentially process the 0b-th to 6b-th coding units CU0b to CU6b depending on the Z-scan order.

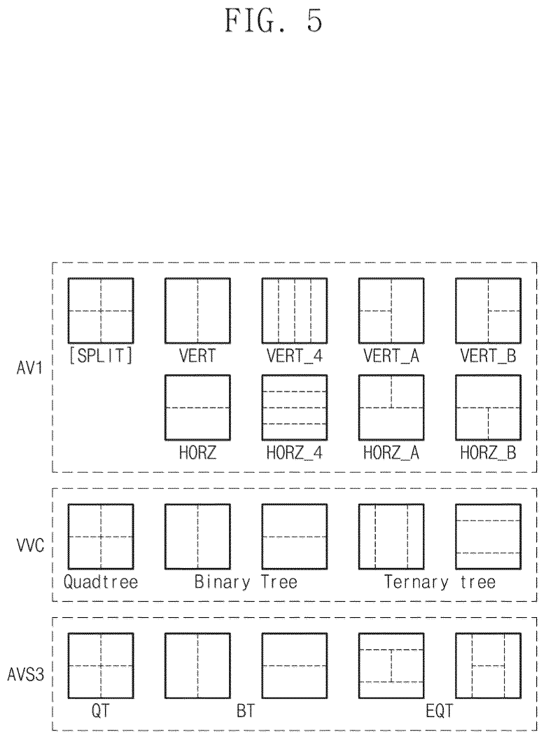

FIG. 5 is a diagram for describing a coding unit partitioning method used in various codecs. As described above, the multi-codec circuit 1140 may support various codecs. In this case, the size and the shape of the coding units CU used in various codecs may be varied depending on the coding unit partitioning method.

For example, as illustrated in FIG. 5, in the AV1 codec, the coding tree unit CTU may be partitioned into a partitioning structure SPLIT, a vertical partitioning structure VERT, a vertical 4-partitioning structure VERT_4, a vertical A-partitioning structure VERT_A, a vertical B-partitioning structure VERT_B, a horizontal partitioning structure HORZ, a horizontal 4-partitioning structure HORZ_4, a horizontal A-partitioning structure HORZ_A, or a horizontal B-partitioning structure HORZ_B. Alternatively, in the VVC codec, the coding tree unit CTU may be partitioned into a quadtree structure, a binary tree structure, or a ternary tree structure. Alternatively, in the AVS3 codec, the coding tree unit CTU may be partitioned into a quadtree structure QT, a binary tree structure BT, or an extended quadtree structure EQT.

As described above, in each codec, the size and the shape of the coding unit CU may be set variously depending on the coding unit partitioning method of the corresponding codec. Alternatively, even in the same codec, the size and the shape of the coding unit CU may be set variously depending on the coding unit partitioning method.

In this case, to determine the availability of neighbor coding units for the current coding unit, various information such as the position, size, shape of the current coding unit, the position, size, shape of neighbor coding units, etc. may be required. This information should be set for each of the plurality of codecs and each of the coding units, which may increase the complexity of the multi-codec circuit 1140. In addition, when a new codec is applied, there is a problem that additional information or circuits should be implemented with respect to the coding units used in the new codec.

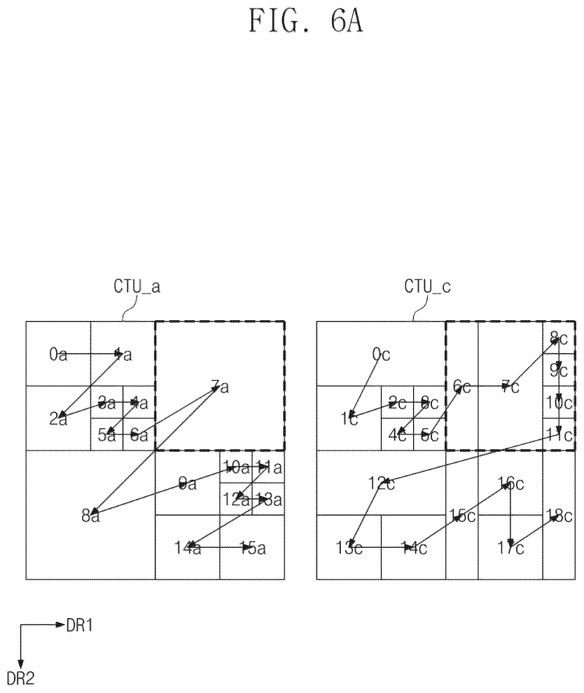

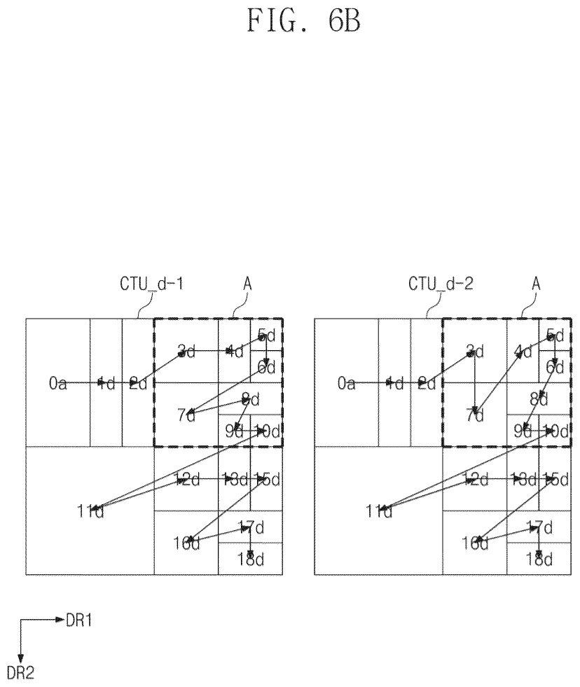

FIGS. 6A and 6B are diagrams for describing an operation for determining the availability of neighbor coding units according to one or more embodiments. Hereinafter, for convenience of description, embodiments of the present disclosure are described focusing on signal processing for one coding tree unit. However, the scope of the present disclosure is not limited thereto, and the multi-codec circuit 1140 may sequentially perform signal processing on a plurality of coding tree units.

In one or more embodiments, the a-th coding tree unit CTU_a illustrated in FIG. 6A illustrates a structure in which coding units are partitioned based on a first codec (e.g., HEVC), and the c-th coding tree unit CTU_c illustrates a structure in which coding units are partitioned based on a second codec (e.g., VVC). In one or more embodiments, the a-th coding tree unit CTU_a and the c-th coding tree unit CTU_c may correspond to the same region in the input image IMG_IN.

That is, when different codecs are applied to the same region of the input image IMG_IN, the size or the shape of the coding unit CU may change. In this case, the sizes and the shapes of neighbor coding units corresponding to the current coding unit may be different. For example, for the a-th coding tree unit CTU_a, it is assumed that the 9a-th coding unit CU9a is the current coding unit. In this case, the neighbor coding units may include CU6a, CU7a, CU8a, CU10a, CU12a, CU14a, and CU15a. In contrast, in a c-th coding tree unit CTU_c, it is assumed that a 15c-th coding unit CU15c in a similar position is the current coding unit. In this case, the neighbor coding units may include CU5c, CU6c, CU7c, CU12c, CU14c, CU16c, and CU17c.

Therefore, even though the input image IMG_IN is the same, depending on the type of the corresponding codec, when signals for coding units in similar or identical positions are processed, the size and the shape of the neighbor coding units may change in various ways. That is, depending on the type of the corresponding codec, various information is required to determine the availability of neighbor coding units.

Alternatively, when the processing order for coding units changes, the availability of neighbor coding units may change. For example, as illustrated in FIG. 6B, a d-th coding tree unit CTU_d-1 or CTU_d-2 may be partitioned into 0d-th to 18d-th coding units CU0d to CU18d.

In this case, in some regions, the processing order of (d-1)-th and (d-2)-th coding tree units CTU_d-1 and CTU_d-2 may be different. For example, in an A-th region “A” of FIG. 6B, the (d-1)-th coding tree unit CTU_d-1 may be processed in the order of CU3d→CU4d→CU5d→CU6d→CU7d→CU8d→CU9d→CU10d. In contrast, in the A-th region “A”, the (d-2)-th coding tree unit CTU_d-2 may be processed in the order of CU3d→CU7d→CU4d→CU5d→CU6d→CU8d→CU9d→CU10d.

In one or more embodiments, it is assumed that a 4d-th coding unit CU4d is the current coding unit. In this case, in the (d-1)-th coding tree unit CTU_d-1, available neighbor coding units of the 4d-th coding unit CU4d will be CU3d. In contrast, in the (d-2)-th coding tree unit CTU_d-2, the available neighbor coding units of the 4d-th coding unit CU4d will be CU3d and CU7d. That is, even for coding units of the same type, the available neighbor coding units may be different depending on the different processing order.

As described above, the multi-codec circuit 1140 may perform signal processing (e.g., inter prediction or intra prediction such as motion estimation, motion compensation, etc.) for the input image IMG_IN based on the coding tree unit or the coding unit. As an example, the multi-codec circuit 1140 may perform the signal processing (e.g., the inter prediction or the intra prediction such as the motion estimation, the motion compensation, etc.) described above using the signal processing result with respect to the neighbor coding units (i.e., the available neighbor coding units) of the coding unit currently being signal processed (i.e., the current coding unit) for which signal processing is completed. In this case, since the size or the shape of the coding units is individually defined by each of the plurality of codecs, the size or the shape of the coding units may be different from each other. In addition, the processing order for the coding units may be modified in various ways, and in this case, the available neighbor coding units may be different even for the same coding unit. As described above, to check the availability of the neighbor coding units for the current coding unit, a separate means or information is required. However, since such separate means or information should be individually defined for each of the plurality of codecs, it acts as an increase in complexity or burden for the multi-codec circuit 1140. In addition, when an additional codec is developed in addition to the existing codec, a separate means is required to apply the size and the shape of coding units suitable for the additional codec.

In the present disclosure, a coding unit availability check block that checks the availability of neighbor coding units for a plurality of codecs is provided. As described in more detail below, the coding unit availability check block may check the availability (or whether signal processing is completed) of neighbor coding units for the current coding unit based on the coding unit bitmap. In this case, the availability of neighbor coding units may be checked or determined based on the position of the current coding unit, the size of the current coding unit, and the position of the current coding tree unit, without requiring separate or additional information such as the size, the shape, the depth, etc. of the neighbor coding units. However, such additional information may be optionally used to confirm the availability of neighbor coding units. Also, even though a new codec is added, the availability of neighbor coding units may be checked or determined without additional information or additional hardware.

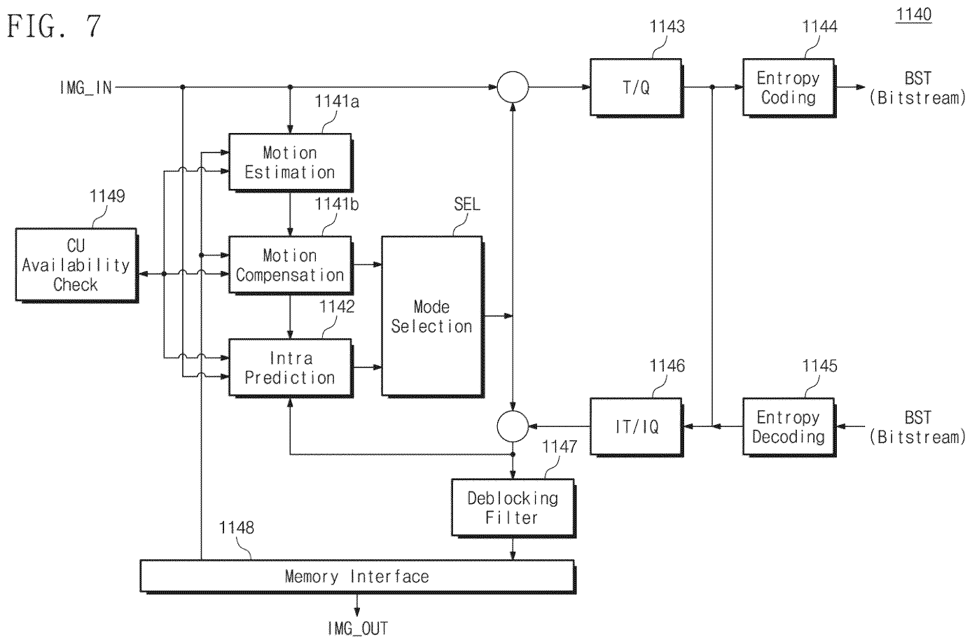

FIG. 7 is a block diagram illustrating a multi-codec circuit of FIG. 1 according to one or more embodiments. Referring to FIG. 1 and FIG. 7, the multi-codec circuit 1140 may include the motion estimation block 1141a, the motion compensation block 1141b, the intra prediction block 1142, the mode selection block SEL, the transform and quantization block 1143, the entropy coding block 1144, the entropy decoding block 1145, the inverse quantization and inverse transform block 1146, the deblocking filter 1147, and the memory interface block 1148. Since the components of the multi-codec circuit 1140 are described with reference to FIG. 2, additional descriptions thereof will be omitted to avoid redundancy.

As illustrated in FIG. 7, the multi-codec circuit 1140 may further include a coding unit availability check block 1149. The coding unit availability check block 1149 may be configured to check the availability of neighbor coding units for the coding unit currently being signal processed in the intra prediction block 1142.

For example, the coding unit availability check block 1149 may include a coding unit bitmap. The coding unit bitmap may include information about signal processing of coding units included in one coding tree unit. The coding unit bitmap may include a plurality of bits. Each of the plurality of bits may correspond to a unit pixel or a minimum unit of coding units used by a plurality of codecs.

The coding unit availability check block 1149 may check the availability of neighbor coding units for the current coding unit based on the coding unit bitmap. For example, in the a-th coding tree unit CTUa of FIG. 6A, it is assumed that a 4a-th coding unit CU4a is the current coding unit. In this case, the coding unit availability check block 1149 may extract reference bits corresponding to the 4a-th coding unit CU4a from the coding unit bitmap. The coding unit availability check block 1149 may determine that the 1a-th, 3a-th, and 5a-th coding units CU1a, CU3a, and CU5a are available based on the reference bits. In this case, the intra prediction block 1142 may perform intra prediction on the 4a-th coding unit CU4a using the processing results (i.e., encoding results or decoding results) of the 1a-th, 3a-th, and 5a-th coding units CU1a, CU3a, and CU5a.

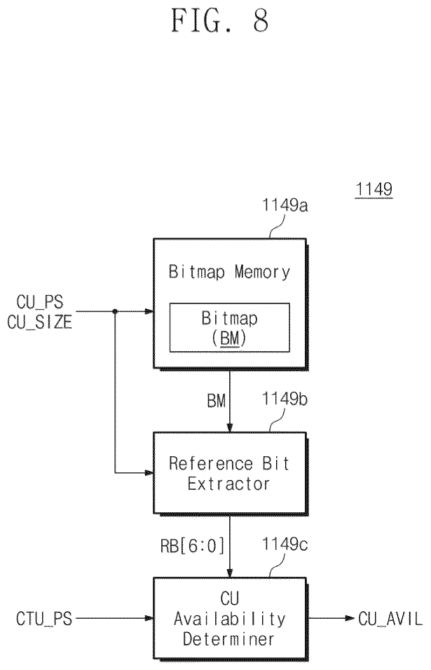

FIG. 8 is a block diagram illustrating a coding unit availability check block of FIG. 7. Referring to FIGS. 7 and 8, the coding unit availability check block 1149 may include a coding unit bitmap memory 1149a, a reference bit extractor 1149b, and a coding unit availability determiner 1149c.

The coding unit bitmap memory 1149a may be configured to store a coding unit bitmap BM. In one or more embodiments, the coding unit bitmap memory 1149a may include high-speed registers, but the scope of the present disclosure is not limited thereto, and may be implemented as a memory such as an SRAM or a DRAM.

The coding unit bitmap BM may correspond to one coding tree unit CTU. Each of the plurality of bits included in the coding unit bitmap BM may correspond to a unit pixel or a minimum unit of a coding unit (e.g., a smallest coding unit size that a codec supports). For example, it is assumed that the multi-codec circuit 1140 supports codecs of H.264, HEVC, AV1, VVC, and AVS3. In this case, the maximum size of the coding tree unit supported by the codecs of H.264, HEVC, AV1, VVC, and AVS3 may be 128×128 in units of pixels. In addition, the size of the minimum unit of the coding unit supported by the codecs of H.264, HEVC, AV1, VVC, and AVS3 may be 4×4. In this case, the coding unit bitmap BM may be composed of bits of (128/4)×(128/4)=32×32. In this case, each bit may correspond to a minimum unit of the coding unit.

When the multi-codec circuit 1140 starts signal processing for the first coding tree unit, the coding unit bitmap BM of the coding unit bitmap memory 1149a may be initialized. For example, all bits of the coding unit bitmap BM of the coding unit bitmap memory 1149a may be initialized by being set to “0”. Afterwards, the multi-codec circuit 1140 may perform signal processing on the plurality of coding units included in the first coding tree unit. As signal processing for each of the plurality of coding units is completed, corresponding bits to the coding unit bitmap of the coding unit bitmap memory 1149a may be set to “1”.

The reference bit extractor 1149b may extract reference bits RB[6:0] from the coding unit bitmap BM based on a position CU_PS of the current coding unit and a size CU_SIZE of the current coding unit. For example, the reference bit extractor 1149b may determine the positions of bits corresponding to the current coding unit in the coding unit bitmap BM, based on the position CU_PS of the current coding unit and the size CU_SIZE of the current coding unit. The reference bit extractor 1149b may output some of bits adjacent to the bits corresponding to the current coding unit as the reference bits RB[6:0].

The coding unit availability determiner 1149c may be configured to determine an available coding unit CU_AVAIL among neighbor coding units based on the reference bits RB[6:0] and a position CTU_PS of the coding tree unit. For example, the coding unit availability determiner 1149c may determine a coding unit corresponding to bits that are “1” among the reference bits RB[6:0] as the available coding unit CU_AVAIL. Alternatively, when the reference bits RB[6:0] do not exist (e.g., when the current coding unit is located at the boundary of the current coding tree unit CTU), the available coding unit may be determined based on the position CTU_PS of the coding tree unit. In one or more embodiments, the signal processing results of the coding units determined as the available coding units may be used for signal processing (e.g., used in intra prediction) of the current coding unit. The operation of the coding unit availability check block 1149 according to one or more embodiments of the present disclosure will be described in more detail with reference to the drawings below.

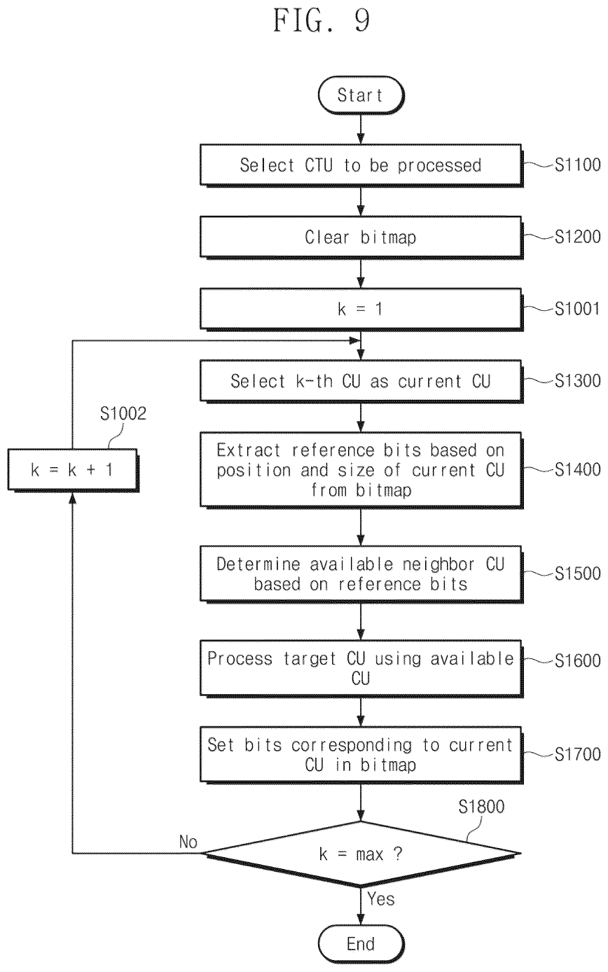

FIG. 9 is a flowchart illustrating an operation of a multi-codec circuit of FIG. 7. Hereinafter, in order to briefly describe one or more embodiments of the present disclosure, the operation of the multi-codec circuit 1140 performing signal processing on a plurality of coding units included in one coding tree unit and the operation of checking the availability of neighbor coding units will be mainly described. However, the scope of the present disclosure is not limited thereto, and the multi-codec circuit 1140 may perform encoding or decoding operations corresponding to the plurality of codecs.

Referring to FIGS. 7 to 9, in operation S1100, the multi-codec circuit 1140 may select the coding tree unit CTU (hereinafter, referred to as “current coding tree unit CTU” for convenience of description) on which signal processing is to be performed. For example, as described with reference to FIG. 3, the multi-codec circuit 1140 may partition the input image IMG_IN into a plurality of coding tree units. In one or more embodiments, the size of each of the plurality of coding tree units may have a size corresponding to a currently used codec among the plurality of codecs. The multi-codec circuit 1140 may select the current coding tree unit among the plurality of coding tree units.

In operation S1200, the multi-codec circuit 1140 may clear the coding unit bitmap BM. For example, the coding unit availability check block 1149 of the multi-codec circuit 1140 may clear the coding unit bitmap memory 1149a when signal processing for the current coding tree unit is initiated. That is, all bits of the coding unit bitmap BM of the coding unit bitmap memory 1149a may be set to a reset value (e.g., zero “0”).

In operation S1001, a variable “k” may be set to “0”. In one or more embodiments, the variable “k” is intended to describe the repetition of signal processing for the plurality of coding units and shall not be interpreted as having any other technical meaning.

In operation S1300, the multi-codec circuit 1140 may select a k-th coding unit as the current coding unit. For example, the multi-codec circuit 1140 may select the k-th coding unit from among the plurality of coding units included in the current coding tree unit as the current coding unit. In one or more embodiments, the k-th coding unit may be determined according to a predetermined order or a z-scan order.

In operation S1400, the multi-codec circuit 1140 may extract reference bits from the coding unit bitmap BM, based on the position and the size of the current coding unit. For example, the reference bit extractor 1149b of the coding unit availability check block 1149 may determine the position of current bits corresponding to the current coding unit in the coding unit bitmap BM, based on the position and the size of the current coding unit. The reference bit extractor 1149b may extract at least some of the neighbor bits of the current bits as the reference bits.

In operation S1500, the multi-codec circuit 1140 may determine available coding units among the neighbor coding units of the current coding unit based on the reference bits. For example, the coding unit availability determiner 1149c of the coding unit availability check block 1149 may determine the coding units corresponding to the reference bits set to “1” among the reference bits as the available coding units.

In operation S1600, the multi-codec circuit 1140 may perform signal processing (e.g., intra prediction, etc.) on the current coding unit using the available neighbor coding units.

In operation S1700, the multi-codec circuit 1140 may set bits corresponding to the current coding unit among the plurality of bits included in the coding unit bitmap BM to “1.”

In operation S1800, whether the variable “k” is a maximum value may be determined. For example, it may be determined whether signal processing for all coding units included in the current coding tree unit is completed.

When the variable “k” is not the maximum (i.e., when there is an unprocessed coding unit among the plurality of coding units included in the current coding tree unit), in operation S1002, the variable “k” is increased by “1”, and the multi-codec circuit 1140 may repeatedly perform the operations of operations S1300 to S1800.

When the variable “k” is the maximum (i.e., when all of the plurality of coding units included in the current coding tree unit are processed), the multi-codec circuit 1140 may complete signal processing for the current coding tree unit and may continue signal processing for a subsequent coding tree unit.

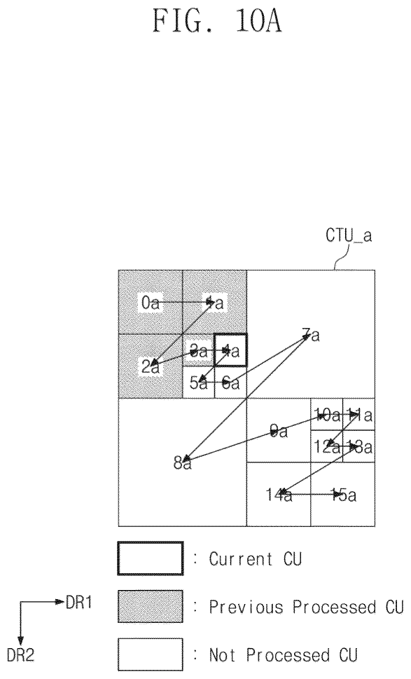

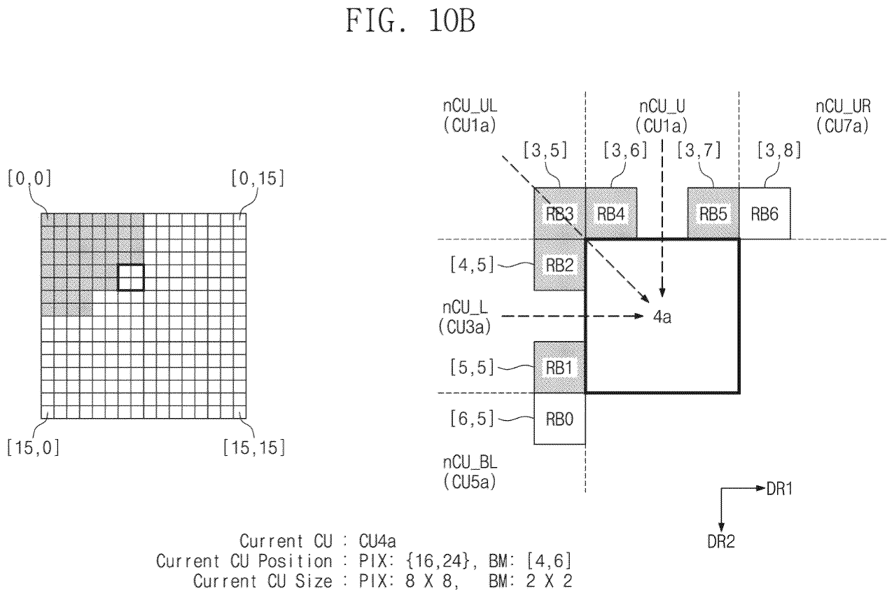

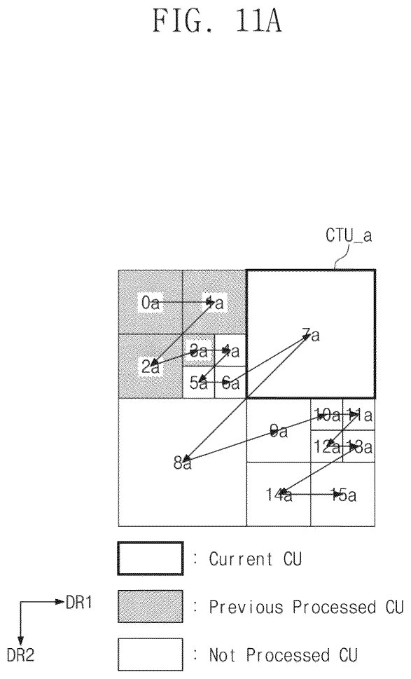

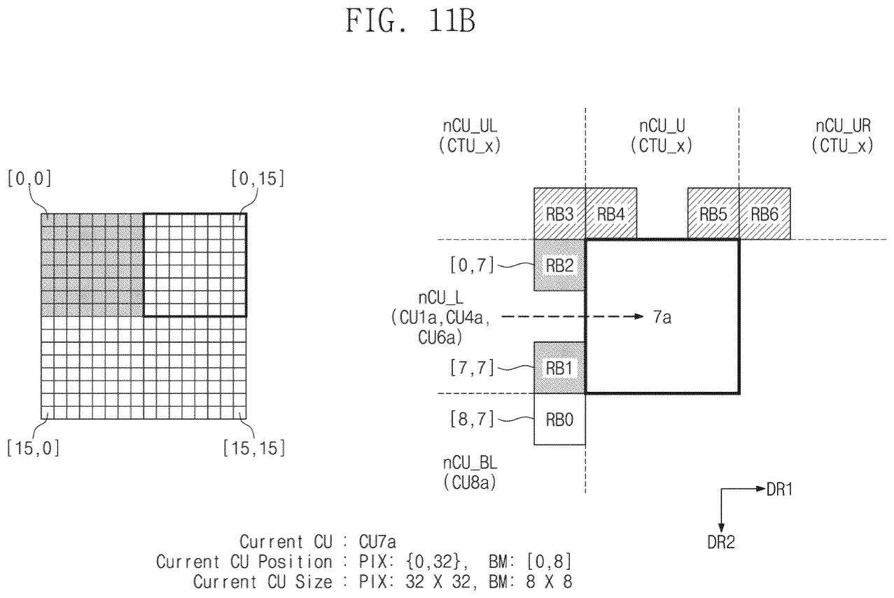

FIGS. 10A, 10B, 11A, and 11B illustrate an operation of a coding unit availability check block of FIG. 8.

Hereinafter, for the convenience of description, signal processing for one coding tree unit CTU is mainly described. In this case, one coding tree unit CTU may have a size of 64×64 in terms of pixels. It is assumed that the coding unit bitmap BM includes a plurality of bits, and each of the plurality of bits corresponds to a minimum unit of coding unit (e.g., a size of 4×4 in terms of pixels). In this case, for a coding tree unit of a size of 64×64, the coding unit bitmap BM may include bits of a size of 16×16.

Hereinafter, symbols of {a, b} or [c, d] are used to express the position of coding units or bits. The {a, b} may be a symbol indicating the coordinate of a pixel in a coding tree unit. That is, the {a, b} may indicate the position of a pixel located in an a-th row and a b-th column in a coding tree unit. The [c, d] may be a symbol indicating the coordinate of a bit in the coding unit bitmap BM. That is, the [c, d] may indicate the position of a bit located in a c-th row and a d-th column in the coding unit bitmap BM.

For convenience of description, in FIGS. 10A to 11B, it is assumed that the multi-codec circuit 1140 performs signal processing on the a-th coding tree unit CTU_a. In this case, the a-th coding tree unit CTU_a may have a size of 64×64 based on a unit pixel, may be partitioned into the 0a-th to 15a-th coding units CU0a to CU15a, and the 0a-th to 15a-th coding units CU0a to CU15a may be sequentially processed according to the Z-scan order.

Referring to FIGS. 7, 8, 10A, and 10B, the multi-codec circuit 1140 may complete signal processing for the 0a-th, 1a-th, 2a-th, and 3a-th coding units CU0a, CU1 a, CU2a, and CU3a. Therefore, at this point in time, the multi-codec circuit 1140 may perform signal processing on the 4a-th coding unit CU4a. That is, the 4a-th coding unit CU4a may be the current coding unit.

In this case, the coding unit bitmap BM may be as illustrated in FIG. 10B. For example, the coding unit bitmap BM may include 16×16 bits. The position of each bit of the coding unit bitmap BM may be represented as the [c, d] (where, “c” is the position of a row in the coding unit bitmap BM, “d” is the position of a column in the coding unit bitmap BM) as described above. Each bit of the coding unit bitmap BM may correspond to a 4×4 minimum unit coding unit.

In the a-th coding tree unit CTU_a, a 0a-th coding unit CU0a may have a size of 16×16 in terms of pixels and a position of {0,0} in terms of pixels (i.e., the position of the first pixel of the 0a-th coding unit CU0a). In this case, in the coding unit bitmap BM, sixty bits [0,0]-[0,3], [1,0]-[1,3], [2,0]-[2,3], and [3,0]-[3,3] may correspond to the 0a-th coding unit CU0a. As signal processing for the 0a-th coding unit CU0a is completed, sixty bits [0,0]-, [1,0]-[1,3], [2,0]-[2,3], and [3,0]-[3,3] may be set to “1” (gray shaded in FIG. 10B).

Afterwards, signal processing for the 1a-th, 2a-th, and 3a-th coding units CU1a, CU2a, and CU3a is sequentially performed, and as signal processing for the 1a-th, 2a-th, and 3a-th coding units CU1a, CU2a, and CU3a is completed, corresponding bits in the coding unit bitmap BM may be set to “1”.

Afterwards, the multi-codec circuit 1140 may perform signal processing on the 4a-th coding unit CU4a. In this case, the multi-codec circuit 1140 may check the completion of encoding or decoding of the coding units adjacent to the 4a-th coding unit CU4a for intra prediction. In this case, reference bits RB0 to RB6 may be extracted from the coding unit bitmap BM based on the position and the size of the 4a-th coding unit CU4a.

For example, as illustrated in FIGS. 10A and 10B, the position or the start position of the 4a-th coding unit CU4a may be {16,24} in terms of pixels in the a-th coding tree unit CTU_a and [4,6] in terms of the coding unit bitmap BM. The 4a-th coding unit CU4a may have a size of 8×8 in terms of pixels and may correspond to 2×2 bits in terms of the coding unit bitmap BM. In this case, in the coding unit bitmap BM, some of bits adjacent to the bits corresponding to the 4a-th coding unit CU4a may be extracted as the reference bits RB0 to RB6.

For convenience of description, in the coding unit bitmap BM, the bits corresponding to the current coding unit are referred to as current coding bits. For example, when the 4a-th coding unit CU4a is the current coding unit, four bits of [4,6], [4,7], [5,6], and may be referred to as current coding bits in the coding unit bitmap BM.

The reference bit extractor 1149b may extract some of the neighbor bits of the current coding bits as the reference bits RB. As an example, the plurality of reference bits RB0 to RB6 may be extracted according to the following conditions.

In the coding unit bitmap BM, the 0-th reference bit RB0 may be a bit of [X+S_h, Y−1], the first reference bit RB1 may be a bit of [X+S_h−1, Y−1], the second reference bit RB2 may be a bit of [X, Y−1], the third reference bit RB3 may be a bit of [X−1, Y−1], the fourth reference bit RB4 may be a bit of [X−1, Y], the fifth reference bit RB5 may be a bit of [X−1, Y+S_w−1], and the sixth reference bit RB6 may be a bit of [X−1, Y+S_w].

In this case, “X” may indicate a row position of a bit corresponding to a start position of the current coding unit, “Y” may indicate a column position of a bit corresponding to a start position of the current coding unit, S_h may indicate a height of bits in the coding unit bitmap BM corresponding to a size of the current coding unit, and S_w may indicate a width of bits in the coding unit bitmap BM corresponding to a size of the current coding unit.

The 0-th reference bit RB0 may be a bit for checking the availability of a bottom left neighbor coding unit nCU_BL located at the bottom left of the current coding unit. The first reference bit RB1 or the second reference bit RB2 may be a bit for checking the availability of a left neighbor coding unit nCU_L located at the left of the current coding unit. The 3-th reference bit RB3 may be a bit for checking the availability of an upper left neighbor coding unit nCU_UL located at the upper left of the current coding unit. The fourth reference bit RB4 or the fifth reference bit RB5 may be a bit for checking the availability of an upper neighbor coding unit nCU_U located at the upper end of the current coding unit. The sixth reference bit RB6 may be a bit for checking the availability of an upper right neighbor coding unit nCU_UR located at the upper right of the current coding unit. In one or more embodiments, based on the current coding unit, the right side may correspond to the first direction DR1, the left side may correspond to the opposite direction of the first direction DR1, the bottom side may correspond to the second direction DR2, and the upper side may correspond to the opposite direction of the second direction DR2.

In the embodiment of FIG. 10B, when the 4a-th coding unit CU4a is the current coding unit, “X” will be “4”, “Y” will be “6”, S_h will be “2”, and S_w will be “2”. Therefore, the 0-th reference bit RB0 will be a bit of [6,5], the first reference bit RB1 will be a bit of [5,5], the second reference bit RB2 will be a bit of [4,5], the third reference bit RB3 will be a bit of [3,5], the fourth reference bit RB4 will be a bit of [3,6], the fifth reference bit RB5 will be a bit of [3,7], and the sixth reference bit RB6 will be a bit of [3,8].

As illustrated in FIG. 10B, the 0-th and sixth reference bits RB0 and RB6 may be “0”. In this case, the bottom left neighbor coding unit nCU_BL (e.g., Cu5a) corresponding to the 0-th reference bit RB0 and the upper right neighbor coding unit nCU_UR (e.g., Cu7a) corresponding to the sixth reference bit RB6 may be determined as unavailable (i.e., not yet processed).

As illustrated in FIG. 10B, the first, second, third, fourth, and fifth reference bits RB1, RB2, RB3, RB4, and RB5 will be “1”. In this case, the left neighbor coding unit nCU_L (e.g., CU3a) corresponding to the first and second reference bits RB1 and RB2, the upper left neighbor coding unit nCU_UL (e.g., CU1a) corresponding to the third reference bit RB3, and the upper neighbor coding unit nCU_U (e.g., CU1a) corresponding to the fourth and fifth reference bits RB4 and RB5 may be determined to be available (i.e., processed).

When the 4a-th coding unit CU4a is the current coding unit, the 1a-th and 3a-th coding units CU1a and CU3a may be determined to be available based on the above-described operation. Accordingly, the multi-codec circuit 1140 may perform signal processing (e.g., intra prediction) on the 4a-th coding unit CU4a using the processing results for the 1a-th and 3a-th coding units CU1a and CU3a. In one or more embodiments, in response to the completion of signal processing for the 4a-th coding unit CU4a, current coding bits (e.g., [4,6], [4,7], [5,6], and [5,7]) in the coding unit bitmap BM may be set to “1”.

Next, referring to FIGS. 7, 8, 11A, and 11B, the multi-codec circuit 1140 may perform signal processing on the 7a-th coding unit CU7a. That is, the 7a-th coding unit CU7a may be selected as the current coding unit. In this case, since the 0a-th to 6a-th coding units CU0a to CU6a are in a state of being processed, corresponding bits are set to “1” in the coding unit bitmap BM, as illustrated in FIG. 11B.

The position of the 7a-th coding unit CU7a may be {0,32} in terms of pixels, and may be [0,8] in terms of the coding unit bitmap BM. The size of the 7a-th coding unit CU7a may be 32×32 in terms of pixels.

In this case, as in the above description, the 0-th reference bit RB0 may be a bit of [8,7], the first reference bit RB1 may be a bit of [7,7], and the second reference bit RB2 may be a bit of [0,7]. Meanwhile, the 7a-th coding unit CU7a may be located at the boundary of the a-th coding tree unit CTU_a. For example, the start position of the seventh coding unit CU7a is {0,32} in terms of pixels. In this case, the upper surface of the seventh coding unit CU7a, i.e., the surface located in the opposite direction to the second direction DR2, is located on the boundary surface of the a-th coding tree unit CTU_a.

When the upper surface of the seventh coding unit CU7a is located on the boundary surface of the a-th coding tree unit CTU_a, the third to sixth reference bits RB3 to RB6 which are located outside the a-th coding tree unit CTU_a, may not be extracted from the coding unit bitmap BM. In this case, the availability of the neighbor coding units (e.g., nCU_UL, nCU_U, nCU_UR) located on the upper surface (i.e., the boundary surface) of the 7a-th coding unit CU7a may be checked or determined based on the position of the a-th coding tree unit CTU_a, which is the current coding tree unit.

For example, the upper neighbor coding units adjacent to the upper surface of the 7a-th coding unit CU7a may be coding units included in another coding tree unit CTU_x. As an example, as described with reference to FIG. 3, the coding tree unit located on the upper surface (the surface opposite to the second direction DR2) of the a-th coding tree unit CTU_a, which is the current coding tree unit, may be in a state of being processed. That is, all coding units adjacent to the upper surface of the 7a-th coding unit CU7a may be in a state of being processed (i.e., available state). Therefore, based on the position of the a-th coding tree unit CTU_a, which is the current coding tree unit, it may be determined that all neighbor coding units (e.g., nCU_UL, nCU_U, and nCU_UR) located on the upper surface (i.e., the boundary surface) of the 7a-th coding unit CU7a are available.

Alternatively, when the a-th coding tree unit CTU_a is located at the 0-th row (i.e., the first row) of the input image IMG_IN, the coding tree unit or the coding unit adjacent to the upper surface of the a-th coding tree unit CTU_a does not exist. In this case, it may be determined that the neighbor coding units (e.g., nCU_UL, nCU_U, and nCU_UR) located at the upper surface (i.e., the boundary surface) of the 7a-th coding unit CU7a do not exist or are not available. In detail, signal processing for the 7a-th coding unit CU7a may be performed without using the neighbor coding units (e.g., nCU_UL, nCU_U, and nCU_UR) located at the upper surface (i.e., the boundary surface) of the 7a-th coding unit CU7a.

As a result, as illustrated in FIG. 11B, when the 7a-th coding unit CU7a located at the boundary of the a-th coding tree unit CTU_a is the current coding unit, the left neighbor coding units, for example, the 1a-th, 4a-th, and 6a-th coding units CU1a, CU4a, and CU6a, may be determined to be available (i.e., processed), based on the first and second reference bits RB1 and RB2. In addition, based on the position of the a-th coding tree unit CTU_a, all of the upper neighbor coding units of the 7a-th coding unit CU7 a (e.g., coding units of CTU_x) may be determined to be available (i.e., processed).

The multi-codec circuit 1140 may perform signal processing (e.g., intra prediction) on the 7a-th coding unit using the available neighbor coding units. In one or more embodiments, in response to completion of signal processing for the 7a-th coding unit CU_7a, the corresponding current coding bits (e.g., 64 bits of [0,8] to [8,15]) in the coding unit bitmap BM may be set to “1”.

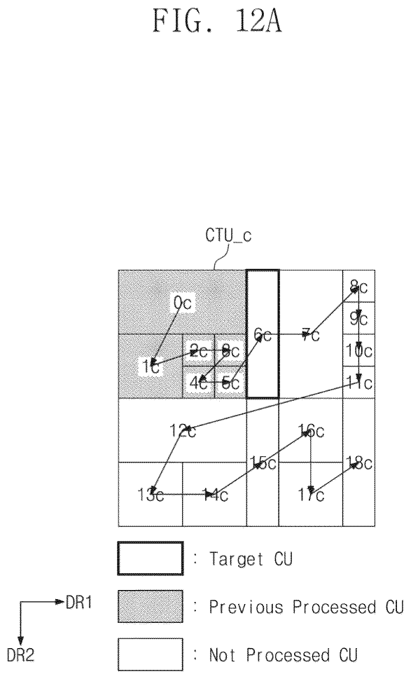

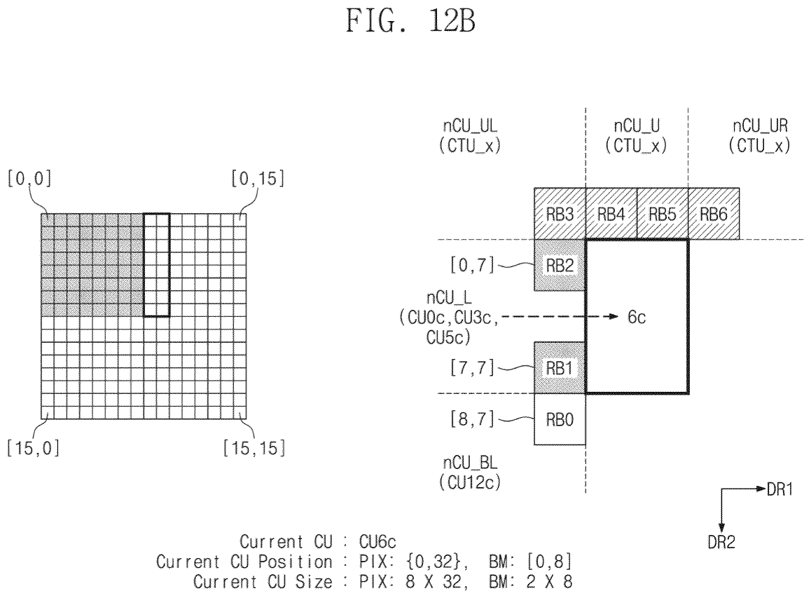

FIGS. 12A and 12B illustrate an operation of a coding unit availability check block of FIG. 8. In the embodiments of FIGS. 10A to 11B, the multi-codec circuit 1140 performs partitioning on coding units based on the HEVC codec. That is, in the embodiments of FIGS. 10A to 11B, the coding units have a square shape. However, the scope of the present disclosure is not limited thereto, and the multi-codec circuit 1140 may support various codecs, and the coding units may have various sizes or shapes depending on the target codec. In this case, the coding unit availability check block 1149 of the multi-codec circuit 1140 may check the availability of the neighbor coding units in the same manner or without additional hardware.

Referring to FIGS. 7, 8, 12A, and 12B, the multi-codec circuit 1140 may perform signal processing on the c-th coding tree unit CTU_c. As an example, as described with reference to FIG. 6A, the c-th coding tree unit CTU_c may be a coding tree unit in which coding unit partition based on the VVC codec is performed. That is, some of a plurality of coding units CU0c to CU18c included in the c-th coding tree unit CTU_c may be square, and some of the remaining may not be square. In this case, the availability of neighbor coding units may be checked similarly to the methods described with reference to FIGS. 10A to 11B.

For example, it is assumed that the 6c-th coding unit CU6c is the current coding unit. In this case, signal processing for the 0c-th to 5c-th coding units CU0c to CU5 c is completed. Therefore, as illustrated in FIG. 12B, bits (e.g., 64 bits of [0,0] to [7,7]) corresponding to the 0c-th to 5c-th coding units CU0c to CU5c in the coding unit bitmap BM are set to “1”.

As illustrated in FIG. 12B, the current coding unit is the 6c-th coding unit CU6c, and the position of the 6c-th coding unit CU6 c may be {0,32} in terms of pixels and in terms of the coding unit bitmap BM. The size of the 6c-th coding unit CU6c may be 8×32 in terms of pixels and 2×8 in terms of the coding unit bitmap BM.

In this case, as in the above description, the 0-th reference bit RB0 may be a bit of [8,7], the first reference bit RB1 may be a bit of [7,7], and the second reference bit RB2 may be a bit of [0,7]. Since the bit of [8,7] of the 0-th reference bit RB0 is “0”, the bottom left neighbor coding unit CU12c is determined to be unavailable (i.e., not processed). Since the bit of [7,7] of the first reference bit RB1 and the bit of [0,7] of the second reference bit RB2 are both “1”, the left neighbor coding units CU0c, CU3c, and CU5c are determined to be available.

In one or more embodiments, the upper surface of the 6c-th coding unit CU6c may be adjacent to the boundary surface of the c-th coding tree unit CTU_c. In this case, as in the above described with reference to FIGS. 11a and 11b, the availability of the neighbor coding units on the upper surface of the 6c-th coding unit CU6c may be checked or determined based on the position of the c-th coding tree unit CTU_c. For example, when signal processing for the coding tree unit CTU_x located on the upper surface of the c-th coding tree unit CTU_c is completed, the neighbor coding units on the upper surface of the 6c-th coding unit CU6c may be determined to be available.

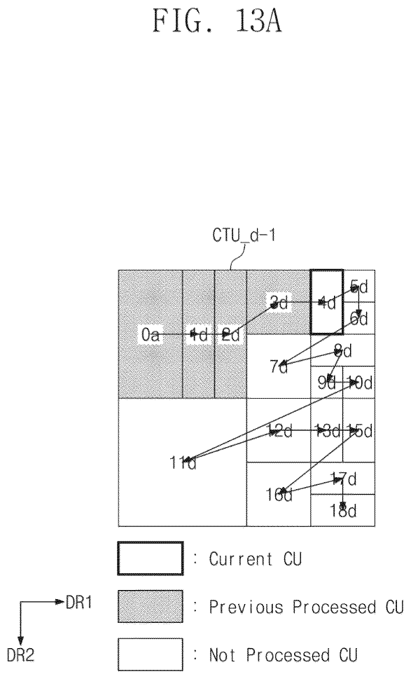

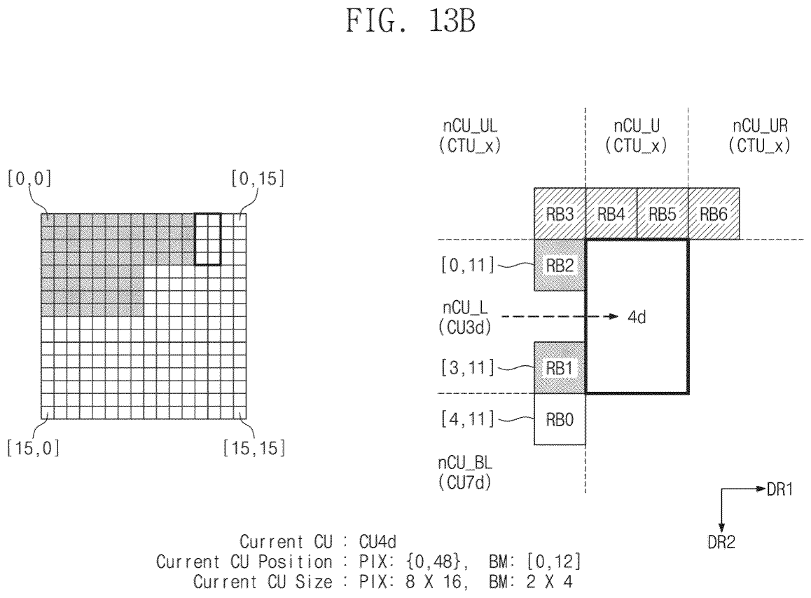

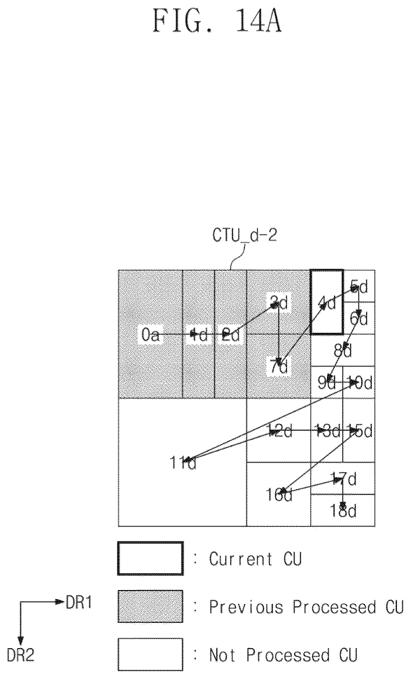

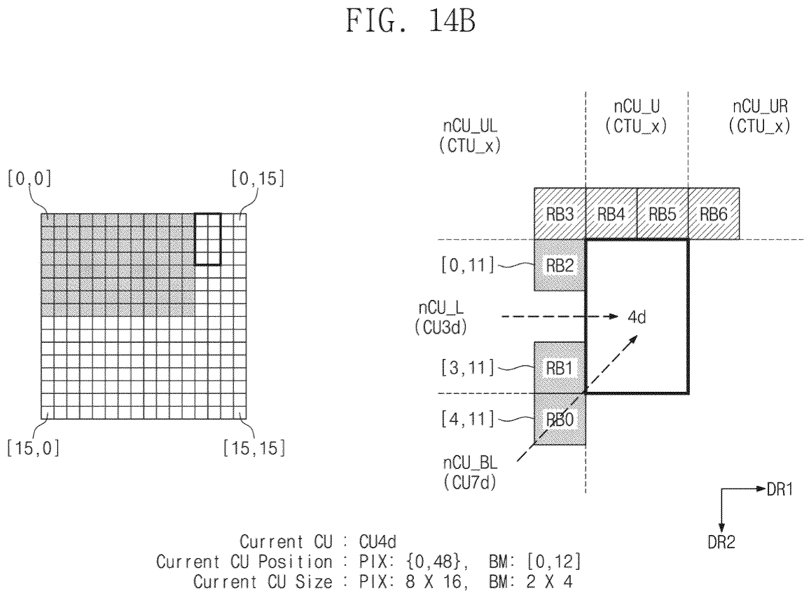

FIGS. 13A, 13B, 14A, and 14B illustrate an operation of a coding unit availability check block of FIG. 8. For convenience of description, additional description associated with the components or operations described above will be omitted to avoid redundancy.

Referring to FIGS. 7, 8, 13A, and 13B, the multi-codec circuit 1140 may perform signal processing on a (d-1)-th coding tree unit CTU_d-1. For example, the (d-1)-th coding tree unit CTU_d-1 may be partitioned into the 0d-th to 18d-th coding units CU0d to CU18d.

In one or more embodiments, it is assumed that the 4d-th coding unit CU4d is the current coding unit. In this case, as illustrated in FIG. 13A, signal processing for the coding units may be performed in the order of CU0d→CU1d→CU2d→CU3d→CU4d.

In this case, as illustrated in FIG. 13B, in the coding unit bitmap BM, bits corresponding to the 0d-th, 1d-th, 2d-th, and 3d-th coding units CU0d, CU1d, CU2d, and CU3d may be set to “1”. The position of the 4d-th coding unit CU4d may be {0,48} in terms of pixels and [0,12] in terms of the coding unit bitmap BM. The size of the 4d-th coding unit CU4d may be 8×16 in terms of pixels and 2×4 in terms of the coding unit bitmap BM.

In this case, as in the above description, the 0-th reference bit RB0 may be a bit of [4,11], the first reference bit RB1 may be a bit of [3,11], and the second reference bit RB2 may be a bit of [0,11]. Therefore, since the bit of [4,11], which is the 0-th reference bit RB0, is “0”, the bottom left neighbor coding unit (e.g., CU7d) is determined to be unavailable. Since the bit of [3,11], which is the first reference bit RB1, and the bit of [0,11], which is the second reference bit RB2, are “1”, the left-side neighbor coding unit (e.g., CU3d) is determined to be available. In one or more embodiments, since the 4d-th coding unit CU4d is adjacent to the boundary of the (d-1)-th coding tree unit CTU_d-1, the third to sixth reference bits RB3 to RB6 are not extracted, and the availability of the neighbor coding units on the upper surface of the 4d-th coding unit CU4d may be determined based on the position of the (d-1)-th coding tree unit CTU_d-1. This is similar to what is described with reference to FIGS. 11A and 11B, and thus additional description thereof is omitted to avoid redundancy.

Next, referring to FIGS. 7, 8, 14A, and 14B, the multi-codec circuit 1140 may perform signal processing on the (d-2)-th coding tree unit CTU_d-2. For example, the (d-2)-th coding tree unit CTU_d-2 may be partitioned into the 0d-th to 18d-th coding units CU0d to CU18d.

In one or more embodiments, the (d-1)-th and (d-2)-th coding tree units CTU_d-1 and CTU_d-2 may be partitioned in the same coding unit partition method. That is, the coding units included in the (d-1)-th and (d-2)-th coding tree units CTU_d-1 and CTU_d-2 may have the same size or the same shape. In contrast, the processing order for the coding units in the (d-1)-th and (d-2)-th coding tree units CTU_d-1 and CTU_d-2 may be different. For example, as illustrated in FIG. 14A, for the (d-2)-th coding tree unit CTU_d-2, signal processing for the coding units may be performed in the order of CU0d→CU1d→CU2d→CU3d→CU7d→CU4d.

In this case, it is assumed that the 4d-th coding unit CU4 d is the current coding unit, as described above. In this case, since signal processing for the 0d-th, 1d-th, 2d-th, 3d-th, and 7d-th coding units CU0d, CU1d, CU2d, CU3d, and CU7d is completed, bits corresponding to the 0d-th, 1d-th, 2d-th, 3d-th, and 7d-th coding units CU0d, CU1d, CU2d, CU3d, and CU7d in the coding unit bitmap BM are set to “1”.

The position of the 4d-th coding unit CU4d may be {0,48} in terms of pixels and [0,12] in terms of the coding unit bitmap BM. The size of the 4d-th coding unit CU4d may be 8×16 in terms of pixels and 2×4 in terms of the coding unit bitmap BM. In this case, as in the above description, the 0-th reference bit RB0 may be a bit of [4,11], the first reference bit RB1 may be a bit of [3,11], and the second reference bit RB2 may be a bit of [0,11].

In this case, since the bit of [4,11], which is the 0-th reference bit RB0, is “1”, the neighbor coding unit (e.g., CU7d) on the bottom left is determined to be available, and since the bit of [3,11], which is the first reference bit RB1, and the bit of [0,11], which is the second reference bit RB2, are “1”, the neighbor coding unit (e.g., CU3d) on the left side is determined to be available. In one or more embodiments, since the 4d-th coding unit CU4d is adjacent to the boundary of the (d-2)-th coding tree unit CTU_d-2, the third to sixth reference bits RB3 to RB6 are not extracted, and the availability of the neighbor coding units on the upper surface of the 4d-th coding unit CU4d may be determined based on the position of the (d-2)-th coding tree unit CTU_d-2. This is similar to what is described with reference to FIGS. 11A and 11B, and thus additional description thereof is omitted to avoid redundancy.

As described with reference to FIGS. 13A to 14B, the multi-codec circuit 1140 according to the embodiment of the present disclosure may easily check the availability of the neighbor coding units without additional information or additional hardware, even though the processing order of coding units is changed.

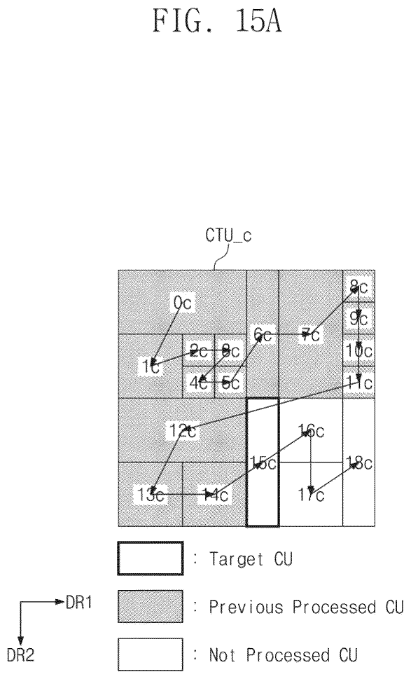

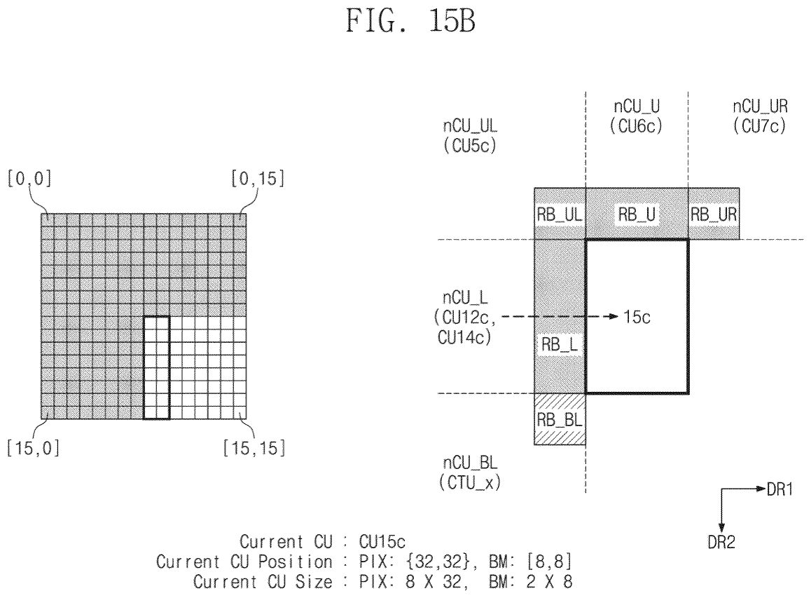

FIGS. 15A and 15B illustrate an operation of a coding unit availability check block of FIG. 8. For convenience of description, additional description associated with the components or operations described above will be omitted to avoid redundancy.

Referring to FIGS. 7, 8, 15A, and 15B, the multi-codec circuit 1140 may perform signal processing on the c-th coding tree unit CTU_c. The c-th coding tree unit CTU_c may be partitioned into the 0c-th to 18c-th coding units CU0c to CU18c. The multi-codec circuit 1140 may sequentially perform signal processing on the 0c-th to 18c-th coding units CU0c to CU18c.

In this case, it is assumed that the 15c-th coding unit CU15c is the current coding unit. In this case, as illustrated in FIG. 15B, bits corresponding to the 0c-th to 14c-th coding units CU0c-CU14c may be set to “1” in the coding unit bitmap BM.

The position of the 15c-th coding unit CU15c may be {32,32} in terms of pixels and [8,8] in terms of the coding unit bitmap BM. The size of the 15c-th coding unit CU15c may be 8×32 in terms of pixels and 2×8 in terms of the coding unit bitmap BM.

In one or more embodiments, the reference bit extractor 1149b of the coding unit availability check block 1149 may extract surrounding bits of bits corresponding to the 15c-th coding unit CU15c in the coding unit bitmap BM as reference bits RM. For example, in the coding unit bitmap BM, the bits corresponding to the 15c-th coding unit CU15c may be [8, 8] to [8, 15] and [9, 8] to [9, 15]. In this case, the left bits of the bits corresponding to the 15c-th coding unit CU15c, for example, [7, 8] to [7, 15] may be extracted as left reference bits RB_L. The upper left bits of the bits corresponding to the 15c-th coding unit CU15c, for example, [7, 7], may be extracted as upper left reference bits RB_UL. The upper bits of the bits corresponding to the 15c-th coding unit CU15c, for example, [8, 7] and [9, 7], may be extracted as upper reference bits RB_U. The upper right bits of the bits corresponding to the 15c-th coding unit CU15c, for example, [7, 9], may be extracted as upper right reference bits RB_UR.

Based on the left reference bits RB_L, the availability of the left neighbor coding unit (e.g., CU12c and CU14c) may be checked, based on the upper left reference bits RB_UL, the availability of the left upper neighbor coding unit (e.g., CU5c) may be checked, based on the upper reference bits RB_U, the availability of the upper neighbor coding unit (e.g., CU6c) may be checked, and based on the upper right reference bits RB_UR, the availability of the right upper neighbor coding unit (e.g., CU7c) may be checked. In one or more embodiments, since the bottom side of the 15c-th coding unit CU15c is adjacent to the boundary of the c-th coding tree unit CTU_c, the availability of the neighbor coding units at the bottom side of the 15c-th coding unit CU15c may be checked based on the position of the c-th coding tree unit CTU_c.

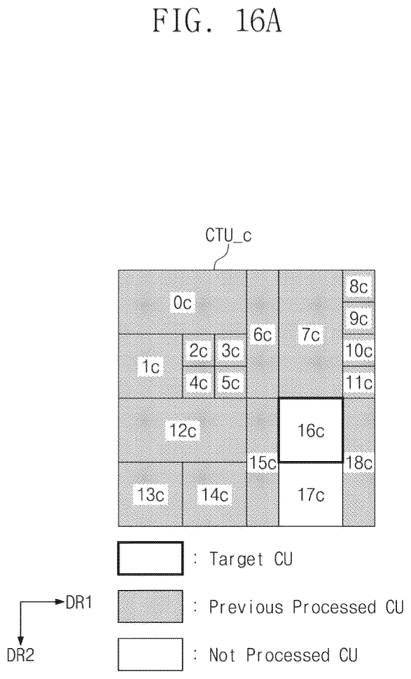

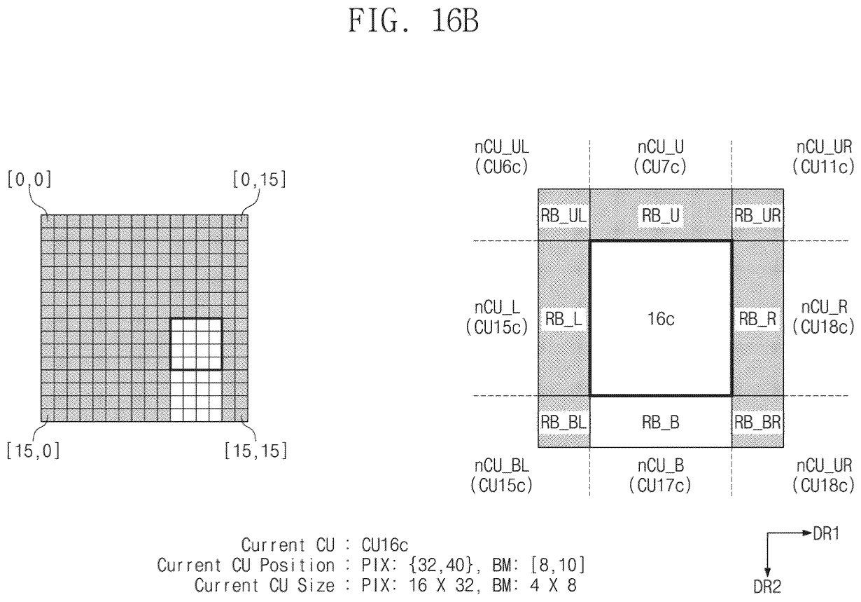

FIGS. 16A and 16B illustrate an operation of a coding unit availability check block of FIG. 8. For convenience of description, additional description associated with the components or operations described above will be omitted to avoid redundancy.

Referring to FIGS. 7, 8, 16A, and 16B, the multi-codec circuit 1140 may perform signal processing on the c-th coding tree unit CTU_c. The c-th coding tree unit CTU_c may be partitioned into the 0c-th to 18c-th coding units CU0c to CU18c. In one or more embodiments, the multi-codec circuit 1140 may perform signal processing on the 0c-th to 18c-th coding units CU0c-CU18c non-sequentially.

For example, it is assumed that the 16c-th coding unit CU16c is the current coding unit. In this case, the 0c-th to 15c-th, and 18c-th coding units CU0c to CU15c, and CU18c may be in a state where signal processing is completed. Accordingly, in the coding unit bitmap BM, bits corresponding to the 0c-th to 15c-th, and 18c-th coding units CU0c to CU15c, and CU18c may be set to “1”.

In this case, the reference bit extractor 1149b of the coding unit availability check block 1149 may extract all surrounding bits of the bits corresponding to the 16c-th coding unit CU16c from the coding unit bitmap BM as the reference bits RM. For example, the position of the 16c-th coding unit CU16c may be {32,40} in terms of pixels and [8,10] in terms of the coding unit bitmap BM. The size of the 16c-th coding unit CU16c may be 16×32 in terms of pixels and 4×8 in terms of the coding unit bitmap BM.

In the coding unit bitmap BM, the current coding bits and the neighbor bits corresponding to the 16c-th coding unit CU16c may be extracted as the reference bits RB. For example, based on the current coding bits, the upper left bit may be extracted as the upper left reference bit RB_UL, the upper bits may be extracted as the upper reference bits RB_U, the upper right bits may be extracted as the upper right reference bits RB_UR, the right bits may be extracted as the right reference bits RB_R, the bottom right bits may be extracted as the bottom right reference bits RB_BR, the bottom bits may be extracted as the bottom reference bits RB_B, the bottom left bit may be extracted as the bottom left reference bits RB_BL, and the left bits may be extracted as the left reference bits RB_L.

As an example, in the coding unit bitmap BM, the current coding bits corresponding to the 16c-th coding unit CU16c may be 16 bits of [8 to 11, 10 to 13] (i.e., which may be expressed as [8:11, 10:13], or alternatively, as [8, 10] to [11, 10], [8, 11] to [11, 11], [8, 12] to [11, 12], and [8, 13] to [11, 13]). In this case, the upper left reference bit RB_UL may be a bit of [7,9] in the coding unit bitmap BM, the upper reference bits RB_U may be bits of [7, 10 to 13] in the coding unit bitmap BM, the upper right reference bits RB_UR may be bits of [7,14] in the coding unit bitmap BM, the right reference bits RB_R may be bits of [8 to 11, 14] in the coding unit bitmap BM, the bottom right reference bits RB_BR may be bits of [12,14] in the coding unit bitmap BM, the bottom reference bits RB_B may be bits of [12, 10 to 13] in the coding unit bitmap BM, the bottom left reference bit RB_BL may be bits of [12,9] in the coding unit bitmap BM, and the left reference bits RB_L may be bits of [8 to 11, 9] in the coding unit bitmap BM.

As illustrated in FIG. 16B, since the remaining reference bits RB_UL, RB_U, RB_UR, RB_R, RB_BR, RB_BL, and RB_L except the bottom reference bit RB_B are all “1”, the neighbor coding units (e.g., CU6c, CU7c, CU11c, CU18c, and CU15c corresponding to the remaining reference bits RB_UL, RB_U, RB_UR, RB_R, RB_BR, RB_BL, and RB_L except the bottom reference bit RB_B may be determined to be available. Therefore, the multi-codec circuit 1140 may perform signal processing (e.g., intra prediction) for the 16c-th coding unit CU16c using the available neighbor coding units (e.g., CU6c, CU7c, CU11c, CU18c, and CU15c).

As described above, according to one or more embodiments of the present disclosure, the multi-codec circuit 1140 may be configured to check the availability of neighbor coding units through the same method even though the sizes, shapes, or processing orders of coding units supported by various codecs are different or the coding unit partition methods are different. Therefore, since individual hardware configurations or additional information are not required to check the availability of coding units for each of the plurality of codecs, the complexity of the multi-codec circuit 1140 may be reduced. In addition, even though an additional codec is developed other than the existing codec, the availability of neighbor coding units may be checked without additional information or additional hardware, and thus, the expandability of the multi-codec circuit 1140 may be improved.

In the above-described embodiments, each of the plurality of bits of the coding unit bitmap BM corresponds to a minimum unit of coding unit. However, the scope of the present disclosure is not limited thereto. For example, each of the plurality of bits of the coding unit bitmap BM may correspond to a single pixel. In this case, the plurality of bits of the coding unit bitmap BM may have a size of M×N, and the size of M×N may correspond to the maximum size of the pixel basis of the coding tree unit.

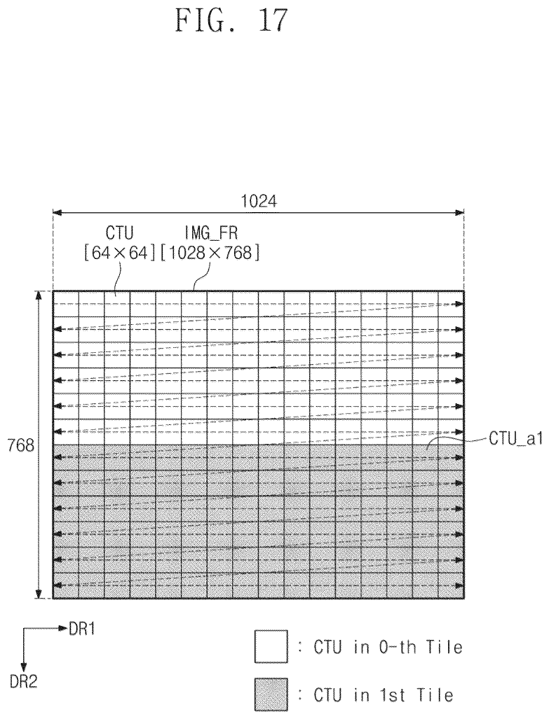

FIG. 17 is a diagram for describing a coding tree unit and a coding unit for an input image processed by a multi-codec circuit of FIG. 1. As illustrated in FIG. 17, the input image IMG_IN may have a size of 1024×768. In this case, the input image IMG_IN may be partitioned into the plurality of coding tree units CTU. As an example, each of the plurality of coding tree units CTU may have a size of 64×64. In this case, for the input image IMG_IN, the plurality of coding tree units CTU may be arranged in a form of 16×12.

As described above, when the current coding unit is located at the boundary of the coding tree unit, the availability of an neighbor coding unit corresponding to the boundary may be checked based on the position of the coding tree unit. In this case, when the coding tree unit is located at the boundary of the input image IMG_IN, it may be determined that the neighbor coding unit corresponding to the boundary does not exist or is not available.

In one or more embodiments, the input image IMG_IN may be partitioned into a plurality of tiles. For example, the input image IMG_IN may be partitioned into 0th and first tiles TILE0 and TILE1. The 0th tile TILE0 may include an upper region of the input image IMG_IN, and the first tile TILE1 may include a bottom region of the input image IMG_IN. As an example, among the plurality of coding tree units CTU in the form of 16×12, the coding tree units located in the 0th to seventh rows may be included in the 0th tile TILE0, and the coding tree units located in the eighth to fifteenth rows may be included in the first tile TILE1.

In one or more embodiments, the multi-codec circuit 1140 may perform signal processing on the 0th and first tiles TILE0 and TILE1 in parallel or independently. In this case, the coding tree units located in the 0th row and the coding tree units located in the eighth row may be processed in parallel. In this case, in checking the availability of neighbor coding units, the boundary of the 0th and first tiles TILE0 and TILE1 may be considered to be the same as the boundary of the input image IMG_IN.

For example, an a1-th coding tree unit CTU_a1 is not located at the boundary of the input image IMG_IN. However, as described above, since the 0th and first tiles TILE0 and TILE1 are processed in parallel, when a signal for the a1-th coding tree unit CTU_a1 is processed, the coding tree unit located on the upper surface of the a1-th coding tree unit CTU_a1 may not processed yet. Therefore, the coding tree unit or coding unit located on the upper surface of the a1-th coding tree unit CTU_a1 may be determined to not exist or to be unavailable.

In one or more embodiments, the coding unit availability check block 1149 of the multi-codec circuit 1140 may further include an additional coding unit bitmap for the coding tree unit. The additional coding unit bitmap may include a plurality of bits indicating whether the plurality of coding tree units included in the input image IMG_IN are processed. The coding unit availability check block 1149 may determine the availability of coding units included in the coding tree units adjacent to the current coding tree unit based on the additional coding unit bitmap. In one or more embodiments, the additional coding unit bitmap may include a plurality of bits, and each of the plurality of bits may correspond to a minimum unit of the coding tree unit supported by each of the plurality of codecs.

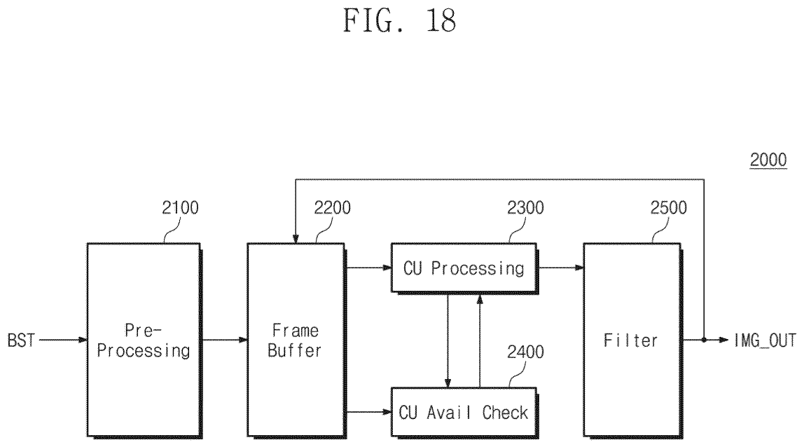

FIG. 18 is a block diagram schematically illustrating a multi-codec circuit, according to one or more embodiments of the present disclosure. Referring to FIG. 18, a decoding operation of a multi-codec circuit 2000 according to one or more embodiments of the present disclosure is briefly described. However, the scope of the present disclosure is not limited thereto, and the multi-codec circuit 2000 may further include additional hardware for performing encoding or decoding corresponding to each of a plurality of codecs.

Referring to FIG. 18, the multi-codec circuit 2000 may include a pre-processing block 2100, a frame buffer 2200, a coding unit processing block 2300, a coding unit availability check block 2400, and a filter 2500.

The pre-processing block 2100 may perform a pre-processing operation on the bitstream BST. For example, the bitstream BST may be compressed data that is obtained by encoding the input image IMG_IN. The pre-processing block 2100 may perform entropy decoding on the bit stream BST to generate a decoded image. In one or more embodiments, the pre-processing block 2100 may store the decoded image in the frame buffer 2200.

The coding unit processing block 2300 may perform various signal processing on the image stored in the frame buffer 2200 based on the coding unit. In one or more embodiments, the coding unit processing block 2300 may be configured to perform intra prediction or inter prediction in units of coding units.

The coding unit availability check block 2400 may be configured to check the availability of neighbor coding units with respect to the coding unit being processed by the coding unit processing block 2300. In one or more embodiments, the coding unit availability check block 2400 may be the coding unit availability check block 1149 described with reference to FIGS. 7 to 17 or may check the availability of neighbor coding units based on the operating method described with reference to FIGS. 7 to 17. Based on the check result (i.e., information about available neighbor coding units) of the coding unit availability check block 2400, the coding unit processing block 2300 may perform various signal processing on the coding unit.

The filter 2500 may include a deblocking filter and a Sample Adaptive Offset (SAO) configured to reduce discontinuities at block boundaries and to attenuate ringing artifacts and sample distortions. The filtered information may be stored in the frame buffer 2200 and may be used as a reference image.

As described above, according to one or more embodiments of the present disclosure, the multi-codec circuit may be configured to support the plurality of codecs. The multi-codec circuit may be configured to check the availability of neighbor coding units through the same method even though the sizes, shapes, or processing orders of coding units supported by various codecs are different or the coding unit partition methods are different. Therefore, since individual hardware configurations or additional information are not required for checking the availability of coding units for each of the plurality of codecs, the complexity of the multi-codec circuit 1140 may be reduced. In addition, even though an additional codec is developed other than the existing codecs, the availability of neighbor coding units may be checked without additional information or additional hardware, and thus, the scalability of the multi-codec circuit may be improved.

According to one or more embodiments of the present disclosure, a multi-codec circuit may perform signal processing (e.g., intra prediction, inter prediction, etc.) in units of coding units. In this time, the multi-codec circuit may check the availability of neighbor coding units using a coding unit bitmap. In this case, even though the size, shape, or processing order of coding units is changed for each of various codecs, the availability of neighbor coding units may be checked based on the same configuration or the same method. In addition, even though a new codec other than the existing codec is developed, the availability of neighbor coding units may be checked without additional information or additional hardware. Therefore, the complexity of the multi-codec circuit may be reduced. Accordingly, the multi-codec circuit with reduced cost and improved performance and an operating method thereof are provided.

According to one or more embodiments of the present disclosure, an electronic device may include memory storing instructions and a coding unit bitmap; and at least one processor configured to execute the instructions to: select a current coding tree unit (CTU) from a plurality of CTUs partitioned from an input image; select a current coding unit (CU) from a plurality of CUs partitioned from the current CTU; determine availability of neighbor CUs of the current coding unit based on the coding unit bitmap that comprises a plurality of bits, each of the plurality of bits indicating whether signal processing has been performed for a corresponding coding unit, among the plurality of CUs; perform signal processing on the current CU using at least one of the neighbor CUs being determined to be available; and update coding bits corresponding to the current coding unit in the coding unit bitmap, based on a completion of the signal processing for the current CU.

The above descriptions are detail embodiments for carrying out the present disclosure. Embodiments in which a design is changed simply or which are easily changed may be included in the present disclosure as well as one or more embodiments described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

1. A method of operating a multi-codec circuit configured to support a plurality of codecs, the method comprising:
selecting a current coding tree unit (CTU) from a plurality of CTUs partitioned from an input image;
selecting a current coding unit (CU) from a plurality of CUs partitioned from the current CTU;
determining availability of neighbor CUs of the current coding unit based on a coding unit bitmap;
performing signal processing on the current CU using at least one of the neighbor CUs that is determined to be available; and
based on the signal processing on the current CU being completed, updating coding bits corresponding to the current CU in the coding unit bitmap,
wherein the coding unit bitmap comprises a plurality of bits, each of the plurality of bits indicating whether signal processing has been performed for a corresponding coding unit, among the plurality of CUs, and
wherein each of the plurality of bits corresponds to a minimum CU supported by each of the plurality of codecs.

2. The method of claim 1, wherein the plurality of bits of the coding unit bitmap have a size of N×M, where each of N and M is a natural number, and
wherein the size of N×M corresponds to a maximum CTU size supported by each of the plurality of codecs.

3. The method of claim 1, wherein at least two bits in the coding unit bitmap are assigned to represent the coding bits corresponding to the current CU.

4. The method of claim 1, wherein the determining of the availability of the neighbor CUs comprises:
extracting a plurality of reference bits from the coding unit bitmap based on a position and a size of the current CU; and
determining the availability of the neighbor CUs based on the plurality of reference bits.

5. The method of claim 4, wherein in the coding unit bitmap, the plurality of reference bits comprise at least 7 bits adjacent to a current coding bit corresponding to the current CU,.

6. The method of claim 4, wherein the determining of the availability of the neighbor CUs based on the plurality of reference bits comprises:
determining neighbor CUs corresponding to reference bits that indicate completion of signal processing, among the plurality of reference bits, as available neighbor CUs.

7. The method of claim 4, wherein the determining of the availability of the neighbor CUs based on the coding unit bitmap further comprises:
based on the current CU being adjacent to a boundary of the current CTU, determining the neighbor CUs at the boundary as available based on a position of the current CTU.

8. The method of claim 1, further comprising:
based on the current CTU being selected, clearing the plurality of bits of the coding unit bitmap to a reset value.

9. The method of claim 1, wherein the signal processing comprises an inter prediction or an intra prediction.

10. The method of claim 1, wherein the plurality of codecs comprises at least two of Advanced Video Coding (H.264), High Efficiency Video Coding (HEVC), AOMedia Video 1 (AV1), Versatile Video Coding (VVC), or Audio Video Coding Standard 3 (AVS3).

11. A method of operating a multi-codec circuit configured to support a plurality of codecs, the method comprising:
determining availability of first neighbor coding units (CUs) of a first CU, among a plurality of CUs partitioned from a first coding tree unit (CTU), based on a coding unit bitmap;
performing first signal processing on the first CU using the first neighbor CUs based on the first neighbor CUs being determined to be available for the first signal processing;
based on the first signal processing being completed, setting first current coding bits corresponding to the first CU to a first value in the coding unit bitmap;
determining availability of second neighbor CUs of a second CU among the plurality of CUs, based on the coding unit bitmap;
performing a second signal processing on the second CU using the second neighbor CUs based on the second neighbor CUs being determined to be available for the second signal processing; and
based on the second signal processing being completed, setting second current coding bits corresponding to the second CU to the first value, in the coding unit bitmap,
wherein the coding unit bitmap comprises a plurality of bits indicating whether signal processing has been performed for the plurality of CUs, and
wherein each of the plurality of bits corresponds to a minimum CU supported by each of the plurality of codecs.

12. The method of claim 11, wherein the determining of the availability of the first neighbor CUs comprises:
extracting, from the coding unit bitmap, bits adjacent to the first current coding bits corresponding to the first CU as first reference bits; and
determining the availability of the first neighbor CUs based on the first reference bits.

13. The method of claim 12, wherein the determining of the availability of the second neighbor CUs comprises:
extracting, from the coding unit bitmap, bits adjacent to the second current coding bits corresponding to the second CU as second reference bits; and
determining the availability of the second neighbor CUs based on the second reference bits, and
wherein the second reference bits comprises at least one of the first current coding bits set to the first value.

14. The method of claim 13, wherein each of the first reference bits and the second reference bits comprises at least 7 bits among the plurality of bits of the coding unit bitmap.

15. The method of claim 11, wherein the plurality of bits of the coding unit bitmap have a size of N×M, where each of N and M is a natural number, and
wherein the size of N×M corresponds to a maximum CTU size supported by each of the plurality of codecs.

16. The method of claim 11, further comprising:
determining availability of third neighbor CUs adjacent to a third CU among a plurality of CUs partitioned from a second CTU, based on the coding unit bitmap;
performing a third signal processing on the third CU using the available third neighbor CUs based on based on the third neighbor CUs being determined to be available for the third signal processing; and
setting third current coding bits corresponding to the third CU to the first value, in the coding unit bitmap.

17. The method of claim 16, wherein the first CTU is partitioned from a first input image based on a first codec among the plurality of codecs, and
the second CTU is partitioned from a second input image based on a second codec different from the first codec among the plurality of codecs.

18. The method of claim 16, wherein a size of the first CTU is different from a size of the second CTU.

19. The method of claim 16, wherein sizes, shapes, and positions of the first CU, the second CU, and to the third CU are different from each other.

20. A method of operating a multi-codec circuit configured to support a plurality of codecs, the method comprising:
clearing a coding unit bitmap to a reset value;
determining availability of first neighbor coding units (CUs) of a first CU in a first coding tree unit (CTU), based on the coding unit bitmap;
performing first signal processing on the first CU using the first neighbor CUs based on the first neighbor CUs being determined to be available for the first signal processing;
setting first current coding bits corresponding to the first CU to a first value, in the coding unit bitmap;
clearing the coding unit bitmap to the reset value;
determining availability of second neighbor CUs of a second CU in a second CTU, based on the coding unit bitmap;
performing a second signal processing on the second CU using the second neighbor CUs based on the second neighbor CUs being determined to be available for the second signal processing; and
setting second current coding bits corresponding to the second CU to the first value, in the coding unit bitmap,
wherein a size of the first CTU is different from a size of the second CTU,
wherein the coding unit bitmap comprises a plurality of bits indicating whether signal processing has been performed for a plurality of CUs comprising the first CU, the second CU, the first neighbor CUs, and the second neighbor CUs, and
wherein each of the plurality of bits corresponds to a minimum CU supported by each of the plurality of codecs.

21. (canceled)
